(19) United States
(12) Patent Application Publication
(10) Pub. No.: US 2015/0019530 A1
(43) Pub. Date: Jan. 15, 2015

(54) QUERY LANGUAGE FOR UNSTRUCTED DATA

(71) Applicant: Cognitive Electronics, Inc., Boston, MA (US)

(72) Inventor: Andrew C. FELCH, Palo Alto, CA (US)

(21) Appl. No.: 14/328,290

(22) Filed: Jul. 10, 2014

Related U.S. Application Data
(60) Provisional application No. 61/845,034, filed on Jul. 11, 2013.

(51) Int. Cl. G06F 17/30

(52) U.S. Cl. CPC G06F 17/30648
USPC 707/719

(57) ABSTRACT

A system and methods are provided for interactive construction of data queries. One method comprises: generating a query based upon a plurality of user-identified data items, wherein the user-identified data items are data items representing desired results from a query, and wherein information related to the user-identified data items is included in a “given” clause of the query, assigning received input data to a hierarchical set of categories, presenting to a user a plurality of new query results, wherein the plurality of new query results are determined by scanning the received input data to find data elements in the same hierarchical categories as those in the “given” query clause and not in the same hierarchical categories as those of an “unlike” clause of the query, receiving from the user an indication as to whether each query result of the presented plurality of new query results is a desirable query result, adding query results indicated by the user as desirable to the “given” clause of the query, adding query results indicated by the user as undesirable to the “unlike” clause of the query, evaluating a metric indicative of the accuracy of the query, and responsive to a determination that the query achieves a predetermined threshold level of accuracy, storing the query.

### CROSS-REFERENCE TO RELATED APPLICATION

This application claims the benefit of U.S. Provisional Application No. 61/845,034, filed Jul. 11, 2013.

### FIELD OF THE INVENTION

The present invention relates generally to creation of queries for structured and unstructured data repositories.

### BACKGROUND OF THE INVENTION

Unstructured data is typically very voluminous and overwhelms existing computer systems, which is called the Big Data problem. Data in Big Data Repositories may be unstructured and not amenable to solely traditional database query techniques. Furthermore, those requiring results from a Big Data Repositories may lack the database query creation skills to produce desired results. What is needed is a system for allowing users with knowledge regarding desirable results, but without specific knowledge of database query techniques, to cause the creation of queries appropriate for their tasks.

### BRIEF SUMMARY OF THE INVENTION

A system and methods are provided for interactive construction of data queries. One method comprises: generating a query based upon a plurality of user-identified data items, wherein the user-identified data items are data items representing desired results from a query, and wherein information related to the user-identified data items is included in a “given” clause of the query, assigning received input data to a hierarchical set of categories, presenting to a user a plurality of new query results, wherein the plurality of new query results are determined by scanning the received input data to find data elements in the same hierarchical categories as those in the “given” query clause and not in the same hierarchical categories as those of an “unlike” clause of the query, receiving from the user an indication as to whether each query result of the presented plurality of new query results is a desirable query result, adding query results indicated by the user as desirable to the “given” clause of the query, adding query results indicated by the user as undesirable to the “unlike” clause of the query, evaluating a metric indicative of the accuracy of the query, and responsive to a determination that the query achieves a predetermined threshold level of accuracy, storing the query.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings embodiments that are presently preferred. It should be understood, however, that the invention is not limited to the precise arrangements and instrumentalities shown.

FIG. 1 describes an existing data processing system in which data is collected in a traditional database and utilized in a batch configuration (in contrast to “real time”) by Business Directors and Business Development Analysts to influence their decisions and actions;

FIG. 2 depicts an existing batch-style Big Data processing system in which data is collected from various Real-time unstructured data feeds;

FIG. 3 depicts a modern real time Big Data processing system;

FIG. 4 depicts an embodiment of the Real-Time Big Data processing system;

FIG. 5 depicts graphically the clustering of eight text data records hierarchically;

FIG. 6 depicts the clusters in FIG. 5 in their hierarchical organization;

FIG. 7 depicts graphically the hierarchical clustering of the same eight text data elements from FIGS. 5 and 6 along different dimensions, resulting in different clusters;

FIG. 8 depicts the documents in FIGS. 5-7 and the clusters from FIG. 7 in their hierarchical organization;

FIG. 9 depicts the documents in FIGS. 5-7 in their dual hierarchical organization;

FIG. 10 depicts a high level process through which a user can create a CQL query and run it;

FIG. 11 depicts a preferred embodiment of the process through which the Interactive Query Builder 420 constructs CQL queries through interaction with a user;

FIG. 12 depicts a process by which Hierarchies act as filters that add column information to Input Data;

FIGS. 13-19 are an exemplary walk-through of the process depicted in FIG. 11, whereby the user constructs queries by interacting with the Interactive CQL Query Builder;

FIG. 20 depicts an architecture wherein downstream Windowing, Optimizer, and Executor systems receive input from the upstream Filtering systems according to a preferred embodiment of the present invention;

FIG. 21 depicts Column Data comprising Identifier, Hierarchy 1—Level 2 cluster, Hierarchy 1—Level 3 cluster, Hierarchy 2—Level 2 cluster, and Hierarchy 2—Level 3 cluster;

FIG. 22 depicts a case of nested filters;

FIG. 23 depicts a Subroutine Repository Database according to the preferred embodiment of the present invention;

FIG. 24 depicts the internals of the optimizer, along with its interactions with its input, the User, the Subroutine Builder Interface, and the Subroutine Repository Database;

FIG. 25 depicts processes that enable the Optimizer and Subroutine Builder Interface to build subroutines that are likely to succeed according to a User's goals;

FIG. 26 depicts an information processing and data flow diagram that starts with the User interacting with the system;

FIG. 27 depicts how the novel system may scale according to changes in the amount of Input Data that is streamed; and

FIG. 28 depicts how Subroutines are run on particular systems and subnetworks within those systems.

### DETAILED DESCRIPTION OF THE PREFERRED EMBODIMENTS

The invention provides a method by which traditional database queries can be run on unstructured data such as Tweets, audio, and video data. In many cases the unstructured data has some meta-information such as the data's time-of-creation, author, or geographic location; but most if not all of the desired signal is hidden inside the unstructured portion. For example, one may desire to know the mood a tweet's text, such as whether it is angry or happy, but this information is not available unless the text is labeled as such, either by a human or a special mood-detecting computer program. The novel architecture provides a means for users to create computer subroutines, which may themselves integrate, build, and/or configure other subroutines. The primary capability of the novel architecture is the creation of subroutines that extract signal from the unstructured portion of a data stream (series of records). Once this signal is detected for a particular piece of data, it can be categorized by this signal and labeled with its category such that it can be processed by downstream systems that require structured data. In this way, the category of the data, once extracted, represents structure to these downstream systems. In one preferred embodiment, the system extracts hypothesized structure it is not sure of, and downstream systems determine if they are useful for desired purposes, such as predicting the future value of a particular trend (e.g. stock prices, purchase order volume, etc.). Subroutines extracting hypothesized structures that do not end up being useful may eventually be retired and replaced by new hypotheses, and the structures that have proven utility may influence and guide the subroutine building process.

The novel architecture provides a means for scaling the computer system to accommodate the required processing of a given data stream so that it can be processed in real time. Users may make their subroutines or subroutine builders available through a subroutine repository database. A user may provide guidance during the configuration of a sub-routine so that the configuration is educated to the extent that a user has the time and/or resources to educate the subroutine during configuration. The novel system provides a process through which a user may educate a subroutine for improved categorization accuracy. This education process has been designed in a novel way so as to maximize the subroutine's improvement per second of user time spent providing said education. The novel system also learns which subroutines are successful at different tasks by observing prior user experiences. Thus, over time the system improves its ability to help new users build more accurate subroutines, and to build these subroutines with less user interaction.

The structured data extracted by the subroutines can be made available to traditional database technologies such as SQL database clients. The novel system creates candidate queries in these traditional query languages for insertion into user systems. Cognitive Query Language (CQL) queries are SQL queries that operate on structure information (e.g. hypothesized category) that has been extracted by the novel system from an unstructured component.

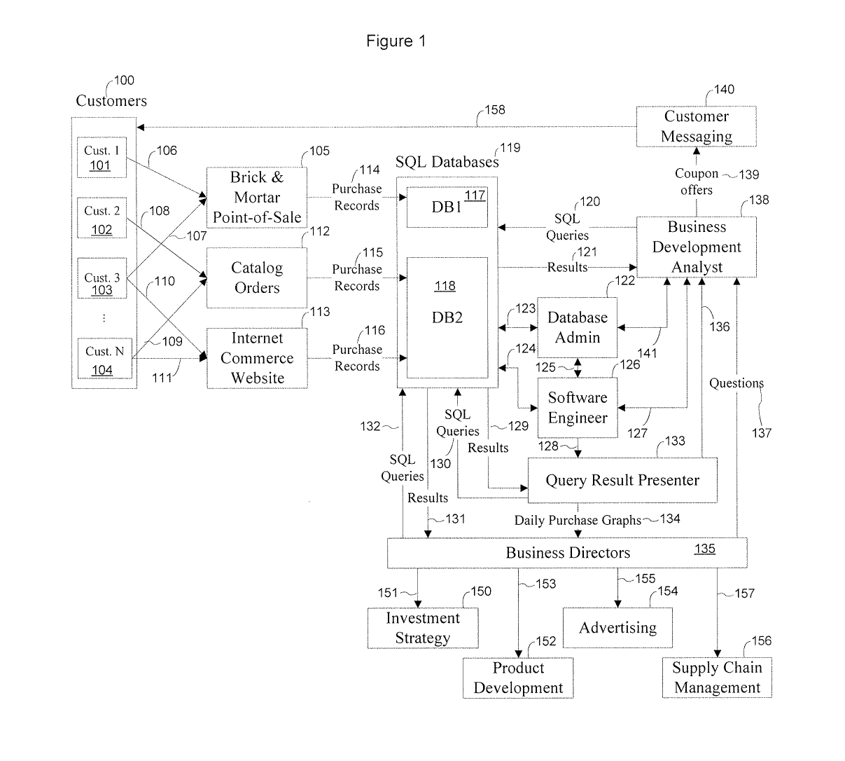

FIG. 1 describes an existing data processing system in which data is collected in a traditional database and utilized in a batch configuration (in contrast to “real time”) by Business Directors and Business Development Analysts to influence their decisions and actions.

In FIG. 1 Customer 1 (101), Customer 2 (102), Customer 3 (103) through Customer N (104) comprise the set of Customers (100) purchasing goods from a company. These Customers 100 purchase these goods in three different ways. Customer 1 (101) and Customer 3 (103) are shown making purchases from the Brick & Mortar Point-of-Sale (105) via links 106 and 107 respectively. Customer 2 (102) and Customer N (104) are shown making purchases via Catalog Orders (112) via links 108 and 109 respectively. Customer 3 (103) and Customer N (104) are shown making purchases on the Internet Commerce Website (113) via links 110 and 111 respectively. The purchases records are transmitted to the SQL Databases (119) from the Brick & Point-of-Sale (105), Catalog Orders (112), and Internet Commerce Website (113) via links 114, 115, and 116 respectively. The Brick & Mortar Point-of-Sale (105) Purchase Records (114) are stored within the SQL Databases (119) in the DB1 database (117). Purchase Records 115 and 116 from the Catalog Orders (112) and Internet Commerce Website (113) respectively are stored in the DB2 database (118) of the SQL Databases (119).

Business Directors (135) and Business Development Analysts (138) desire to find insights into the data stored in the SQL Databases (119). Business Directors (135) interface with data in the SQL Databases 119 through multiple methods. If a Business Director 135 has learned the skills required to form SQL Queries that match the questions they would like to ask about the data then they may form these SQL Queries and communicate them via link 132 to the SQL Databases. The Results from these queries may then be communicated back to the Business Director (135) via the Results link 131. Another method by which Business Directors (135) may gain understanding of data stored in SQL Databases (119) is by reviewing the Daily Purchase Graphs (134) presented to the Business Directors (135) by the Query Result Presenter (133). Queries are used to generate these graphs. These queries are input to the Query Result Presenter (133) by the Software Engineer (126) via link 128.

FIG. 1 may be described further from the perspective of the Business Directors (135). In the case that the Business Directors (135) are not being presented with the information they would like to analyze by the Query Result Presenter 133 in Daily Purchase Graphs 134 (or any other presented results from Query Result Presenter 133), and the Business Directors (135) can't or do not want to directly query the databases (117, 118) via links 132 and 131, then the Business Directors (135) may ask questions (137) of their Business Development Analysts (138). The Business Development Analysts (138) receives questions (137) from the Business Directors (135) and may also generate questions on their own. The Business Development Analysts (138) may convert these questions into SQL Queries (120) they present to the SQL Databases (119). Results from these queries may be sent back to the Business Development Analyst (138) via Results link 121.

The Business Development Analyst 138 may not want or be able to SQL Queries (120) from the questions they want answers to. In this case they may ask assistance from a Database Administrator (122) through dialog link 141. The database Administrator (122) may communicate with the Software Engineer (126) via dialog link 125 and may configure the SQL Databases (119) via link 123 such that the databases (119) are more suitable for query by the Business Development Analyst (138). The Database Administrator may advise the Business Development Analyst (138) of what queries they might communicate to the Databases (119) via link 120 in order to retrieve Results (121) that answer the questions they have about the data. Upon successful analysis of the data with respect to these questions, the Business Development Analyst (138) may communicate with the Software Engineer (127) through dialog (127) in order to load the Query Result Presenter (133) with Queries via link 128 such that the Results (129) from those queries (130) are presentable to the Business Directors in graphs such as Daily Purchase Graphs (134). Alternatively, the Business Development Analyst (138) may require the Software Engineer's (126) help in designing queries for the SQL Databases (119), which the Software Engineer will develop by utilizing the SQL Databases via link 124 and communicating with the Database Administrator (122) via link 125. Upon performing successful analysis the Business Development Analyst (138) may observe the results presented by the Query Result Presenter (133) through link 136. The Business Development Analyst (138) may then act on this analysis by offering coupons to customers which are sent via the “Coupon offers” link (139) to Customer Messaging (140), which sends messages offering coupons via link 158 to Customers (100).

Once the Business Directors have answers to their questions presented to them via link 131 or link 134 they can make decisions based on that information and either advise the Business Development Analysts (138) on further investigation (via link 137), output new strategies (151) to the Investment Strategy Department (150), send advice (153) to Product Development (152), send advertising ideas (155) to Advertising (154), or convey supply chain concerns (157) to Supply Chain Management (156). The Business Directors (135) may advise the Business Development Analyst (138) on possible interactions with the customer that should be initiated such as Coupon offers (139).

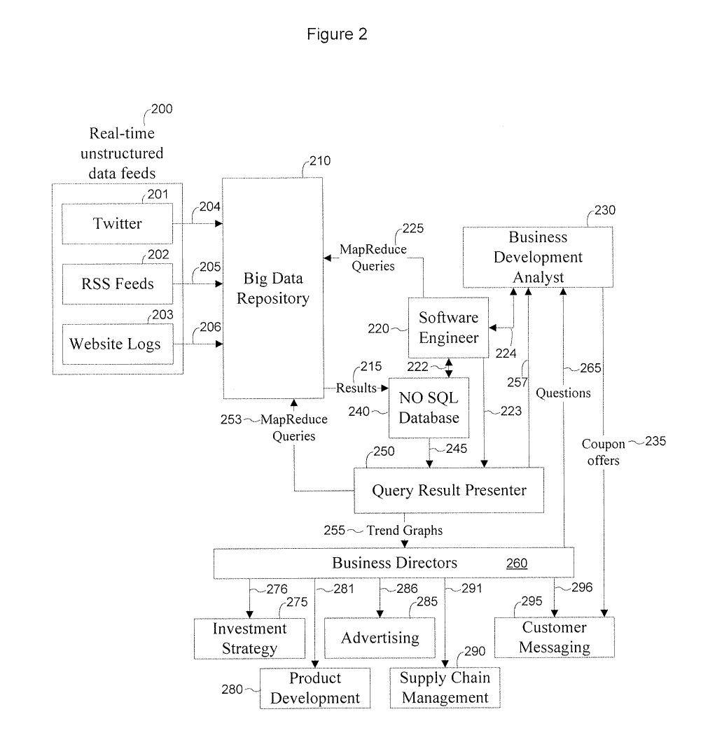

FIG. 2 depicts an existing batch-style Big Data processing system in which data is collected from various Real-time unstructured data feeds (200) such as Twitter (201), RSS Feeds (202), and Website Logs (203). These data sources (201, 202, 203) convey their information to the Big Data repository (210) via links 204, 205, and 206 respectively. Unstructured Big Data is collected in a Big Data Repository (210) where it is processed according to the MapReduce Queries (225, 253) the Big Data Repository (210) receives. The Results (215) of the MapReduce Queries (225, 253) are stored in a Not-Only SQL Database (240). Note that Not-Only SQL may be abbreviated NO SQL. The results of these queries may then be processed by Software Engineers (220) via link 222 and may also be presented to Business Directors (260) and Business Development Analysts (230) as Trend Graphs (255, 257). These Trend Graphs may represent the answers to questions previously asked by Business Directors (260) of Business Development Analysts (230) via link 265.

In the case that a Business Development Analyst (230) has questions about data in the Big Data Repository (210), either their own questions or questions (265) received from Business Directors about the data, they communicate these questions through dialog (224) with a Software Engineer (220). Because the data in the Big Data Repository (210) is unstructured it does not need a schema designed by a database administrator in this example. In actuality it may be the case that most of the data in a data record is unstructured but some of it is structured and represented in SQL databases (119) as in FIG. 1. Data that is unstructured, however, will not be stored in special columns that allow it to be easily queried in a SQL or SQL-like syntax because the key information is not stored as structured columns in a database. The Software Engineer (220) interacts with the Big Data Repository (210) by writing MapReduce Queries which it presents via link 225 to the Big Data Repository (210). The results from these queries are transmitted from the Big Data Repository (210) to the NO SQL Database (240) via the Results link 215, which may be queried by means of NO SQL commands directly by the Software Engineer (220) via link 222. In this way the Software Engineer (220) may learn answers to the questions presented to him/her by the Business Development Analyst (230) via link 224. Once the MapReduce queries that provide useful information with respect to the questions asked of the Software Engineer (220) and/or Business Development Analyst (230) have been written and tested by the Software Engineer (220) they may be loaded into the Query Result Presenter (250) via link 223. The Query Result Presenter (250) may then present answers to the Business Development Analyst (230) and Business Directors (260) via Trend Graphs (255, 257) or some other illustration of the data following these same communication links (225, 257).

Upon receiving answers to previously asked questions the Business Development Analyst (230) may then send Coupon offers (235) to Customer Messaging (295). Similarly, upon receiving answers (255) to previously asked questions the Business Directors (230) may then send Coupon offers (296) to Customer Messaging (295), output new strategies (276) to the Investment Strategy department (275), send advice (281) to Product Development (280), advertising ideas (286) to Advertising (285), or supply chain concerns (291) to Supply Chain Management (290).

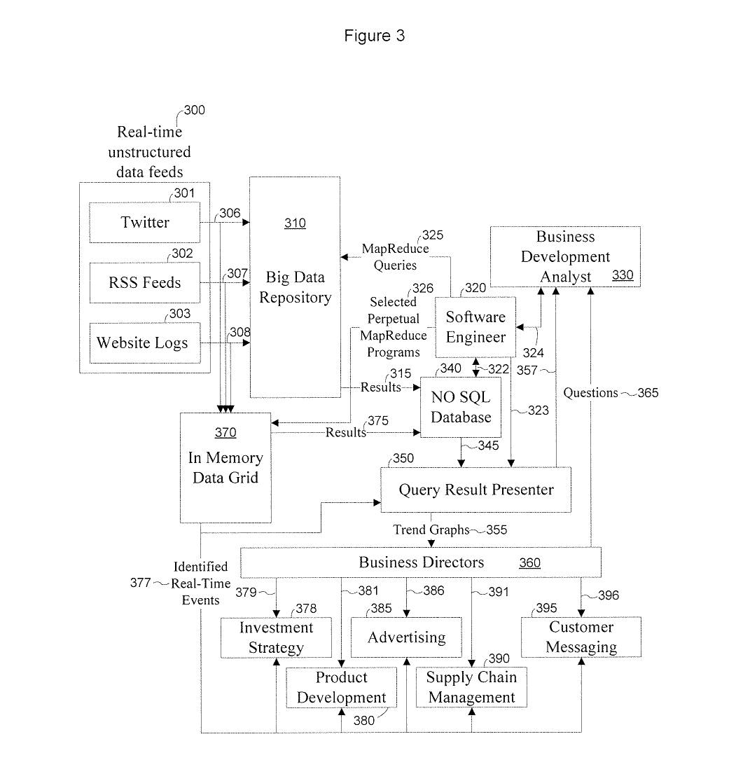

FIG. 3 depicts a modern real time Big Data processing system. The idea behind the example depicted in FIG. 3 is to update the behavior of Investment Strategies (378), Product Development (380), Advertising (385), Supply Chain Management (390), and Customer Messaging (395) in response to new information received in real time from real-time unstructured data feeds (300) such as Twitter (301), RSS Feeds (302), and new log information of current website activity (303). Data from these data sources is communicated via links 306, 307, and 308 respectively. Links 306, 307, and 308 send this real-time unstructured data to both the Big Data Repository (310) and the In Memory Data Grid (370). The Big Data Repository (310) is used for batch style Big Data processing such as in FIG. 2, whereas the In Memory Data Grid (370) storage is used for processing of Big Data in real time. It is noteworthy that Software Engineers (320) use the Big Data Repository (310) for development of MapReduce Queries. The Software Engineer (320) performs this development process by creating MapReduce Queries, sending them to the Big Data Repository (310) via link 325, and analyzing the results (315) of these queries through interaction with the NO SQL Database (340) via link (322). After the Software Engineer (320) analyzes the results, he/she can modify the MapReduce queries and/or create new ones. Results from the Big Data Repository (315) are communicated to the NO SQL database (340) via Results link 315. The Software Engineer (320) reviews these Results in the NO SQL Database (340) via link 322.

Once the Software Engineer (320) has sufficiently developed a set of one or more MapReduce Queries, they may be selected to be run perpetually and in this case they are sent as the “Selected Perpetual MapReduce Programs” (326) to the In Memory Data Grid (370). The In Memory Data Grid (370) then executes these MapReduce programs (326) perpetually on all of the data stored in the In Memory Data Grid. It may be the case that the MapReduce programs (326) update values stored in the In Memory Data Grid (370) and therefore subsequent executions of the MapReduce programs (326) on previously processed data have new results which necessitate the repeated processing. If it is known that an execution of a MapReduce program on previously processed data will not have different results, such as in the case that the data and query configuration have not changed, then a cache of the previous result or a reference to these results can be output from the MapReduce program (possibly for further processing) without requiring re-execution of the MapReduce program on the same data. Such a caching system may be left disabled until it is detected that cached results would have been used, in which case the caching system may be enabled for future processing. The enablement of the result caching system may also have a condition such that enablement only occurs if cached results appear to be of sufficient utility, such as obviating a sufficient amount of MapReduce query re-execution per amount of memory used by the cache.

Business Directors (360) raise questions (365) to Business Development Analysts (330) in order to influence Investment Strategies (378), Product Development (380), Advertising (385), Supply Chain Management (390), and Customer Messaging (395) in response to real-time events via link 377 rather than manually via links 379, 381, 386, 391, and 396 respectively. The Business Development Analyst (330) in turn presents the ideas behind those questions to the Software Engineer (320) via dialog 324. The Software Engineer (320) develops MapReduce Queries (325) which act on Big Data in the Repository (310). Results to these queries are sent via link 315 to the NO SQL Database (340) and are presented back to the Software Engineer (320) possibly through an interactive interface. The results may also be sent to the Query Result Presenter (350) via link 345 through which they may be sent onward to the Business Directors (360) and Business Development Analysts (330) via links 355 and 357 respectively. The Query Result Presenter (350) may present Trend Graphs (355, 357) or another illustration of the Results (315, 375). These Trend Graphs or other illustration (355, 357) may be recognized by the Business Development Analyst (330) as actionable in certain cases. The Identified Real-Time Events that are actionable (377) are sent to the various acting units 378, 380, 385, 390, 395 so that these units can respond to the current trends in real time. The Business Development Analyst (330) and Software Engineer (320) may work together through dialog (324) to refine the Selected Perpetual MapReduce Programs (326) and integrate suggested actions for the Identified Real-Time Events into the Selected Perpetual MapReduce Programs (326) so that these suggested actions are integrated into the message sent via link 377 to the units receiving these messages ((378, 380, 385, 390, 395). The Software Engineer (320) and Business Development Analyst (330) also maintain the set of Selected Perpetual MapReduce Programs (326) such that those queries that are no longer useful are removed from the In Memory Data Grid (370) so that they no longer run.

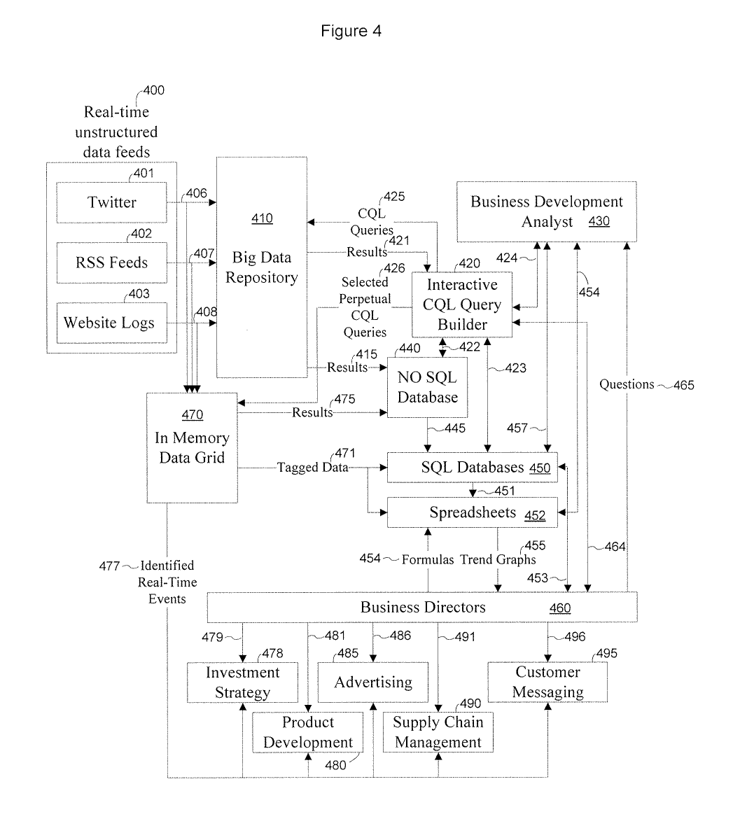

FIG. 4 depicts a preferred embodiment of the novel Real-Time Big Data processing system wherein Business Development Analysts (430) and Business Directors (460) are able to interact with the Real-Time Big Data through an Interactive CQL Query Builder (420) rather than through a Software Engineer (320). The Real-time unstructured data feeds (400), which comprise Twitter data (401), RSS Feeds (402), and Website Logs (403) become input to the Big Data Repository (410) for Batch-Style processing systems via links 406, 407, and 408 respectively. These Real-Time unstructured data (400) are also input to the In Memory Data Grid (470) via links 406, 407, and 408, where it is temporarily stored for immediate Real-Time processing.

Business Directors (460) and Business Development Analysts (430) have questions about their business data and desire that Investment Strategy (478), Product Development (480), Advertising (485), Supply Chain Management (490), and Customer Messaging (495) react instantaneously to important Real-Time Events (477). The Business Directors (460) and/or Business Development Analyst (430) may have an idea of what these events are but they may not know what aspects of the Real-time unstructured data (400) signal these events, or anticipate them into the future, nor do they know how to program computers in a functional programming language. Business Directors (460) may interact with the Interactive CQL Query Builder (420) in order to build these programs through interacting with the Query Builder program (420), or may ask the Business Development Analyst (430) questions communicated via link 465. The Business Development Analyst (430) generates questions and receives questions (465) from the Business Directors (460), and attempts to answer these questions through interaction with the Interactive CQL Query Builder (420) via link 424.

The Interactive CQL Query Builder (420) creates CQL Queries based on interactions with Business Directors (460) and/or Business Development Analysts (430) via links 464 and 424 respectively. These interactions provide the Business Development Analyst (430) and/or Business Directors (460) with opportunities to guide the query building process, such as selection of an input data stream, selection of trends for prediction, or submission of example data that represent desired query results. The Interactive CQL Query Builder (420) constructs queries during this process and tests them on the Big Data Repository (410) to estimate what subsequent interaction with the Business Development Analyst (430) will be the most useful, or whether such interactions are no longer necessary. The results (421) of the CQL Queries (425) are received by the Interactive CQL Query Builder (420). Some or all of these results (421) are presented to the user in an effort to refine or fix the CQL Queries under development. CQL Queries (425) may alternatively return results via the Results link (415) so that they are input to the NO SQL Database (440). The Interactive CQL Query Builder (420) may then perform further analyses on the results (415) through repeated interaction with the NO SQL Database (440) via link 422.

In this preferred embodiment the user is either a Business Development Analyst (430) or Business Director (460). Once the user is satisfied with the results (421) returned by the CQL Queries (425), the Interactive Query Builder (420) communicates these queries to the In Memory Data Grid (470) through the Selected Perpetual CQL Queries link (426) for perpetual processing within the In Memory Data Grid (470), thereby processing (and reprocessing as necessary) all new real-time unstructured data (400). The Interactive CQL Query Builder (420) may also configure SQL Databases (450) via link 423 such that data in the NO SQL Database (440) is sent to the SQL Databases (450) via link 445. Data in the SQL Databases (450) may then be queried using traditional SQL Queries by the Business Directors (460) via link 453, and by Business Development Analysts (430) via link 457. The SQL Databases (450) also receive the results of Selected Perpetual CQL Queries (426) running within the In Memory Data Grid (470) as Tagged Data (471). Spreadsheets (452) also receive this data either directly via link 471 or indirectly from the SQL Databases (450) via link 451. The Spreadsheets (452) are configured with Formulas received via link 454 from Business Directors (460) or via link 454 from Business Development Analysts (430). Script code such as VBScript may also be sent so that the Spreadsheets (452) may be endowed with the ability to perform built-in actions in response to newly arriving data (451, 471). The Spreadsheets (452) act as a simplified interface for visualizing the results of CQL Queries executing on Real Time Data. Any Business Director (460) and Business Development Analyst (430) has the ability to create different visualizations of the data since they have experience working with spreadsheets. For example, the Business Directors (460) may submit Formulas (454) to the Spreadsheets (452) that produce visualized Trend Graphs (455). Business Development Analysts (430) may perform similar interactions with the Spreadsheets (452) via link 454.

The Selected Perpetual CQL Queries (426), which are run on the In Memory Data Grid (470), identify Real-Time Events (477) and these are sent to Investment Strategy (478), Product Development (480), Advertising (485), Supply Chain Management (490), and Customer Messaging (495) so that these systems can respond to the results of the real-time data analysis performed within the In Memory Data Grid (470). The In Memory Data Grid (470) identifies Real-Time Events (477) by executing the Selected Perpetual CQL Queries (426) and these are sent to Investment Strategy (478), Product Development (480), Advertising (485), Supply Chain Management (490), and Customer Messaging (495). Investment Strategy (478), Product Development (480), Advertising (485), Supply Chain Management (490), and Customer Messaging (495) may be further configured via links 479, 481, 486, 491, and 496 respectively so that they perform certain actions upon being notified of certain Identified Real-Time Events (477). In another preferred embodiment, the Identified Real-Time Events (477) may be configured to suggest certain actions to the Investment Strategy (478), Product Development (480), Advertising (485), Supply Chain Management (490), and Customer Messaging (495) units through configuration of the Selected Perpetual CQL Queries (426). This configuration may be performed either by the Business Directors (460) via link 464, or by the Business Development Analysts (430) via link 424.

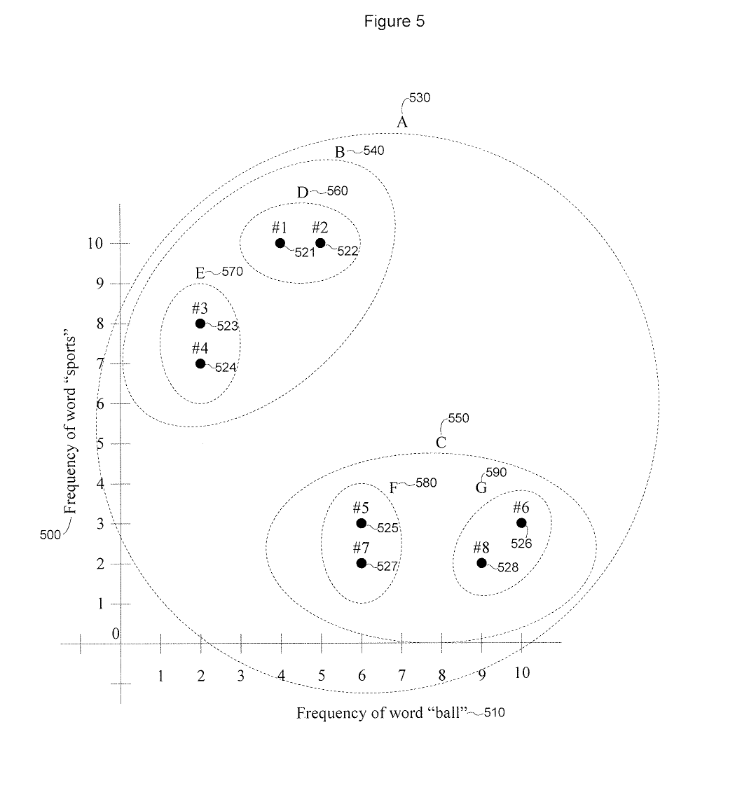

FIG. 5 depicts graphically the clustering of eight text data records hierarchically. The terms “data records” and “data elements” are used interchangeably. The data elements (black dots, 521-528) may be Tweets 401 or RSS Feed data 402, for example. This data may be analyzed with respect to different attributes such as the number of times a certain keyword occurs in the data element. In the FIG. 5 the frequency of the word “sports” represents the Y-Axis of the graph (500) whereas the frequency of word “ball” represents the X-Axis (510).

Data element #1 (521) is graphed at coordinate “(4,10)” because it has 4 occurrences of the word “ball” and 10 occurrences of the word “sports”. Data element #1 521 is graphed at coordinate “(4,10)” because it has 4 occurrences of the word “ball” and 10 occurrences of the word “sports”. Data element #2 (522) is graphed at coordinate “(5,10)” because it has 5 occurrences of the word “ball” and 10 occurrences of the word “sports”. Data element #3 (523) is graphed at coordinate “(2,8)” because it has 2 occurrences of the word “ball” and 8 occurrences of the word “sports”. Data element #4 (524) is graphed at coordinate “(2,7)” because it has 2 occurrences of the word “ball” and 7 occurrences of the word “sports”. Data element #5 (525) is graphed at coordinate “(6,3)” because it has 6 occurrences of the word “ball” and 3 occurrences of the word “sports”. Data element #6 (526) is graphed at coordinate “(10,3)” because it has 10 occurrences of the word “ball” and 3 occurrences of the word “sports”. Data element #7 (527) is graphed at coordinate “(6,3)” because it has 6 occurrences of the word “ball” and 3 occurrences of the word “sports”. Data element #8 (528) is graphed at coordinate “(9,2)” because it has 9 occurrences of the word “ball” and 2 occurrences of the word “sports”.

A primary form of data analysis that does not require the data to be labeled and augmented under human supervision is clustering. Many clustering algorithms exist, and all of them generally share the goal of achieving a description of the data that organizes it into groups such that data that is in the same group are very similar to each other (e.g. containing the same keywords, or same frequency of keywords) and data elements that are not in the same group are not as similar to each other. The means by which the clustering algorithms assign data to groups is different for each clustering algorithm. The size and number of the clusters is in some sense arbitrary although some algorithms try to self configure these variables. One means of compensating for some of the inherent arbitrariness of creating a predetermined number of clusters is to initially create many small clusters (with each group having relatively few data associated with it), and then to create a hierarchy of clusters of clusters, and clusters of clusters of clusters, etc. until all of the data is in one big cluster. When these clusters are configured as a hierarchy, as in FIG. 5, sub-clusters (also called “child clusters”) of a parent cluster do not cross the boundary of the parent cluster. (See that no circles/ovals overlap in FIG. 5). It is also possible to utilize a hierarchical structure during the development of the various clusters, but to then post-process the clusters such that the hierarchical organization is not rigidly adhered to [Chandrashekar A, Granger R (2012) Derivation of a novel efficient supervised learning algorithm from cortical-subcortical loops. Frontiers Comput Neurosci., 5:50].

In FIG. 5 all of the documents 521-528 are depicted as encircled by Cluster A (530) indicating that they are all in Cluster A (530), which is the largest cluster. Cluster B (540) encircles documents #1, #2, #3, and #4 (521-524) indicating that these four documents are in Cluster B (540). Cluster B (540) is also itself encircled by Cluster A (530), indicating that Cluster B (540) is also in Cluster A (530). Cluster C (550) encircles documents #5, #6, #7, and #8 (525-528) indicating that these four documents are in Cluster C (550). Cluster C (550) is also itself encircled by Cluster A (530), indicating that Cluster C (550) is also in Cluster A (530). Cluster D (560) encircles documents #1 and #2 (521, 522) indicating that these two documents are in Cluster D (560). Cluster D 560 is also itself encircled by Cluster B (540) and Cluster A (530), indicating that Cluster D (560) is in these two clusters as well. Cluster E (570) encircles documents #3 and #4 (523, 524) indicating that these two documents are in Cluster E (570). Cluster E (570) is also itself encircled by Cluster B (540) and Cluster A (530), indicating that Cluster E (570) is in these two clusters as well. Cluster F (580) encircles documents #5 and #7 (525, 527) indicating that these two documents are in Cluster F (580). Cluster F (580) is also itself encircled by Cluster C (550) and Cluster A (530), indicating that Cluster F (580) is in these two clusters as well. Cluster G (590) encircles documents #6 and #8 (526, 528) indicating that these two documents are in Cluster G (590). Cluster G (590) is also itself encircled by Cluster C (550) and Cluster A (530), indicating that Cluster G (590) is in these two clusters as well.

Although the clusters depicted in FIG. 5 are shown as ellipses many algorithms partition the space such that within a parent cluster all of the space is either exactly one of the immediate-child clusters, and there is no interior space of the parent cluster that is not in one of the immediate-child clusters. This results in child clusters sharing borders with each other and also with their parent cluster, which can have advantages such as no ambiguity as to what set of clusters a piece of data is in, and also decreased storage costs for the cluster information (since shared boundaries can be stored a single time and referenced individually by those clusters that share that boundary). It is also the case that the borders of a cluster maybe be implied by some other data intrinsic to the cluster. For example a new piece of data may be clustered according to whether it is closer to the centroid point of one cluster or another. The line border between these two clusters is thereby defined as the points in space that are equidistant from the two cluster centroids. The K-Means algorithm [Steinbach, M., Karypis, G., & Kumar, V. (2000, August). A comparison of document clustering techniques. In KDD workshop on text mining (Vol. 400, pp. 525-526)] is such an algorithm and a hierarchical implementation of this algorithm is a preferred embodiment of the novel system.

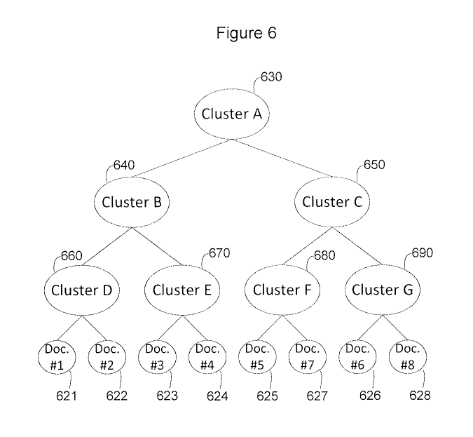

FIG. 6 depicts the clusters in FIG. 5 in their hierarchical organization. Cluster A (630) is the top-level category, which is also termed the Tier-0 category. (We generally use the terms “Categories” and “Clusters” synonymously). All of the eight documents (621-628) are in Cluster A (630) since Cluster A (630) is their ancestor in the hierarchy diagram of FIG. 6. Clusters B, C, D, E, F and G (640, 650, 660, 670, 680, 690) are also in Cluster A (630). Cluster B (640) and Cluster C (650) are the two Tier-1 categories and are child categories of the Tier-0 Cluster A (630). Documents #1, #2, #3, and #4 (621, 622, 623, 624) are in Cluster B (640) since Cluster B 640 is an ancestor to these documents (621-624). In Tier 2, Cluster D (660) and Cluster E (670) are also in Category B (640). Documents #5, #6, #7, and #8 (625, 626, 627, 628) are in Cluster C (650) since Cluster C (650) is an ancestor to these documents (625-628). Tier 2 Clusters F and G (680, 690) are also in Category C (650).

Documents #1 and #2 (621, 622) are in Tier 2 Cluster D (660_since Cluster D (660) is an ancestor of these documents, and is more specifically their parent in the hierarchy, which signifies that Cluster D (660) is also the smallest cluster with these two documents (621, 622) in them. Documents #3 and #4 (623, 624) are in Tier 2 Cluster E (670) since Cluster E (670) is an ancestor of these documents, and is more specifically their parent in the hierarchy, which signifies that Cluster E (670) is also the smallest cluster with these two documents (623, 624) in them. Documents #5 and #7 (625, 627) are in Tier 2 Cluster F (680) since Cluster F (680) is an ancestor of these documents, and is more specifically their parent in the hierarchy, which signifies that Cluster F (680) is also the smallest cluster with these two documents (625, 627) in them. Documents #6 and #8 (626, 628) are in Tier 2 Cluster G (690) since Cluster G (690) is an ancestor of these documents, and is more specifically their parent in the hierarchy, which signifies that Cluster G (690) is also the smallest cluster with these two documents (626, 628) in them.

It is noteworthy that we refer to the top tier of the hierarchy either as Tier-0 or as Level 1. Tier-1 is the next tier down, comprising Cluster B (640) and Cluster C (650), and Tier-1 is also called Level 2. Tier-2 is the next tier down, comprising Clusters D, E, F, and G (660, 670, 680, 690), and Tier-2 is also called Level 3. These terms for Tiers (top to bottom labeled Tier-0 through Tier-2) and Levels (top to bottom labeled Level 1 through Level 3) will be used throughout the document.

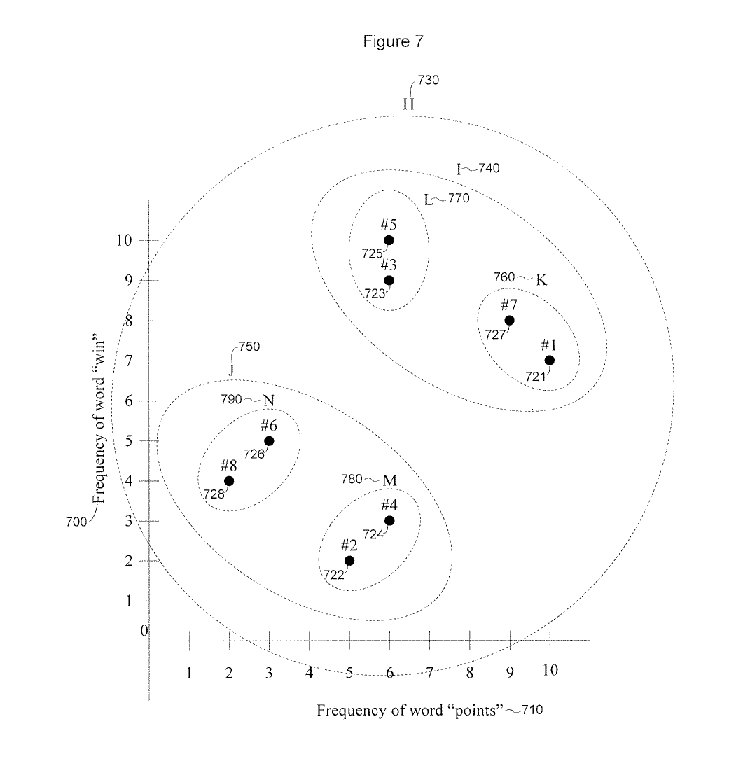

FIG. 7 depicts graphically the hierarchical clustering of the same eight text data elements from FIGS. 5 and 6 along different dimensions, resulting in different clusters labeled H through N (730-790). The data elements (721-728) are analyzed with respect to different attributes such that the frequency of the word “win” represents the Y-Axis of the graph (700) whereas the frequency of word “points” represents the X-Axis (710).

Data element #1 (721) is graphed at coordinate “(10,7)” because it has 10 occurrences of the word “points” and 7 occurrences of the word “win”. Data element #2 (722) is graphed at coordinate “(5,2)” because it has 5 occurrences of the word “points” and 2 occurrences of the word “win”. Data element #3 (723) is graphed at coordinate “(6,9)” because it has 6 occurrences of the word “points” and 9 occurrences of the word “win”. Data element #4 (724) is graphed at coordinate “(6,3)” because it has 6 occurrences of the word “points” and 3 occurrences of the word “win”. Data element #5 (725) is graphed at coordinate “(6,10)” because it has 6 occurrences of the word “points” and 10 occurrences of the word “win”. Data element #6 (726) is graphed at coordinate “(3,5)” because it has 3 occurrences of the word “points” and 5 occurrences of the word “win”. Data element #7 727 is graphed at coordinate “(9,8)” because it has 9 occurrences of the word “points” and 8 occurrences of the word “win”. Data element #8 (728) is graphed at coordinate “(2,4)” because it has 2 occurrences of the word “points” and 4 occurrences of the word “win”.

The clustering algorithms that were options for clustering the documents along the dimensions in FIG. 5 (namely by frequency of the words “ball” and “sports”) are also options for clustering along different dimensions such as those depicted in FIG. 7.

In FIG. 7 all of the documents (721-728) are depicted as encircled by Cluster H (730) indicating that they are all in Cluster H 730, which is the largest cluster. Cluster I (740) encircles documents #1, #3, #5, and #7 (721, 723, 725, 727) indicating that these four documents are in Cluster I (740). Cluster I (740) is also itself encircled by Cluster H (730), indicating that Cluster I (740) is also in Cluster H (730). Cluster J (750) encircles documents #2, #4, #6, and #8 (722, 724, 726, 728) indicating that these four documents are in Cluster J (750). Cluster J (750) is also itself encircled by Cluster H (730), indicating that Cluster J (750) is also in Cluster H (730). Cluster K (760) encircles documents #1 and #7 (721, 727) indicating that these two documents are in Cluster K (760). Cluster K (760) is also itself encircled by Cluster I (740) and Cluster H (730), indicating that Cluster K (760) is in these two clusters as well. Cluster L (770) encircles documents #3 and #5 (723, 725) indicating that these two documents are in Cluster L (770). Cluster L 760 is also itself encircled by Cluster I (740) and Cluster H (730), indicating that Cluster L (760) is in these two clusters as well. Cluster M (780) encircles documents #2 and #4 (722, 724) indicating that these two documents are in Cluster M (780). Cluster M (780) is also itself encircled by Cluster J (750) and Cluster H (730), indicating that Cluster M (780) is in these two clusters as well. Cluster N (790) encircles documents #6 and #8 (726, 728) indicating that these two documents are in Cluster N (790). Cluster N (790) is also itself encircled by Cluster J (750) and Cluster H (730), indicating that Cluster N (790) is in these two clusters as well.

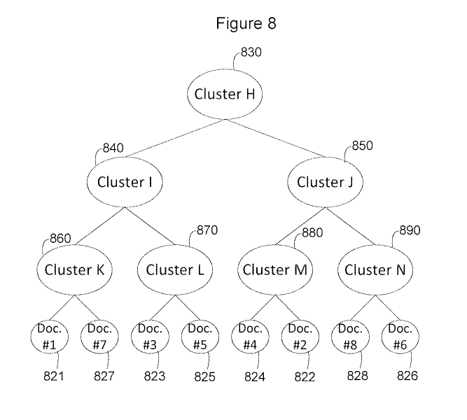

FIG. 8 depicts the documents from FIGS. 5-7 and the clusters from FIG. 7 in their hierarchical organization, which we term Hierarchy 2. Hierarchy 2 clusters the documents (821-828) along different dimensions than the hierarchical clusters of FIGS. 5 & 6, which we term Hierarchy 1. Cluster H (830) is the top-level category, which is also termed Hierarchy 2 Tier-0. All of the eight documents (821-828) are in Cluster H (830) since Cluster H (830) is their ancestor in the diagram of Hierarchy 2. Clusters I, J, K, L, M and N (840, 850, 860, 870, 880, 890) are also in Cluster H (830). Cluster I (840) and Cluster J (850) are the two Hierarchy 2 Tier-1 clusters and are child clusters of the Hierarchy 2 Tier-0 Cluster H (830). Documents #1, #7, #3, and #5 (821, 827, 823, 825) are in Cluster I (840) since Cluster I (840) is an ancestor of these documents (821, 827, 823, 825). In Hierarchy 2 Tier 2 Cluster K (860) and Cluster L (870) are also in Category I (840). Documents #4, #2, #8, and #6 (824, 822, 828, 826) are in Cluster J (850) since Cluster J (850) is an ancestor to these documents (824, 822, 828, 826). Hierarchy 2 Tier 2 Clusters M and N (880, 890) are also in Category J (850).

Documents #1 and #7 (821, 827) are in Hierarchy 2 Tier 2 Cluster K (860) since Cluster K (860) is an ancestor of these documents, and is more specifically their parent in the hierarchy, which signifies that Cluster K (860) is also the smallest cluster with these two documents (821, 827) in them. Documents #3 and #5 (823, 825) are in Hierarchy 2 Tier 2 Cluster L (870) since Cluster L (870) is an ancestor of these documents, and is more specifically their parent in the hierarchy, which signifies that Cluster L (870) is also the smallest cluster with these two documents (823, 825) in them. Documents #4 and #2 (824, 822) are in Hierarchy 2 Tier 2 Cluster M (880) since Cluster M (880) is an ancestor of these documents, and is more specifically their parent in the hierarchy, which signifies that Cluster M (880) is also the smallest cluster with these two documents (824, 822) in them. Documents #8 and #6 (826, 828) are in Hierarchy 2 Tier 2 Cluster N (890) since Cluster N (890) is an ancestor of these documents, and is more specifically their parent in the hierarchy, which signifies that Cluster N (890) is also the smallest cluster with these two documents (826, 828) in them.

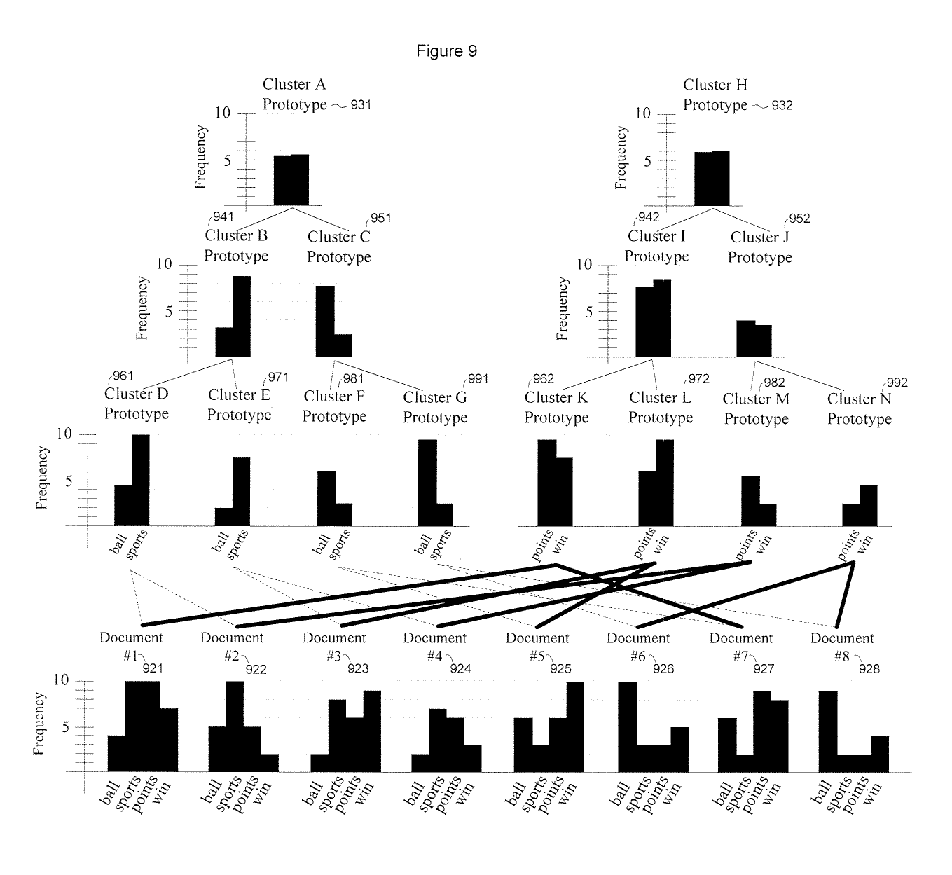

FIG. 9 depicts documents 1-8 (921-928) in their dual hierarchical organization, which correlate to documents 1-8 in previous FIGS. 5-8 and their organization into Hierarchy 1 (clusters in the left half of FIG. 9) from FIGS. 5 and 6, and their organization into Hierarchy 2 (clusters in the right half of FIG. 9) from FIGS. 7 and 8. FIG. 9 illuminates how multiple hierarchies (namely Hierarchy 1 on the left and Hierarchy 2 on the right) organize the same data, and how they may project the data onto different dimensions in order to do this. Furthermore, FIG. 9 depicts how the prototype of a cluster can be derived from the average of the data found in that cluster (this is but one means of deriving prototype values, and other methods may be used).

In the bottom row we find documents 1-8 (921-928) ordered in increasing order from left to right. These represent the same documents from FIGS. 5-8. The values that follow are depicted graphically by the four black bars below the document label, which are labeled from left to right by “ball”, “sports”, “points”, and “win”. Instead of plotting each document in four dimensions we plot four values as four bars in bar-graph form for each document. Values proceed from the bottom line of each bar graph, which indicates 0 occurrences of that word, to the top line of the same bar graph, which indicates 10 occurrences of that word. Document #1 (921) contains 4 occurrences of the word “ball”, 10 occurrences of the word “sports”, 10 occurrences of the word “points” and 7 occurrences of the word “win”. Document #2 (922) contains 5 occurrences of the word “ball”, 10 occurrences of the word “sports”, 5 occurrences of the word “points” and 2 occurrences of the word “win”. Document #3 (923) contains 2 occurrences of the word “ball”, 8 occurrences of the word “sports”, 6 occurrences of the word “points” and 9 occurrences of the word “win”. Document #4 (924) contains 2 occurrences of the word “ball”, 7 occurrences of the word “sports”, 6 occurrences of the word “points” and 3 occurrences of the word “win”. Document #5 (925) contains 6 occurrences of the word “ball”, 3 occurrences of the word “sports”, 6 occurrences of the word “points” and 10 occurrences of the word “win”. Document #6 (926) contains 10 occurrences of the word “ball”, 3 occurrences of the word “sports”, 3 occurrences of the word “points” and 5 occurrences of the word “win”. Document #7 (927) contains 6 occurrences of the word “ball”, 2 occurrences of the word “sports”, 9 occurrences of the word “points” and 8 occurrences of the word “win”. Document #8 (928) contains 9 occurrences of the word “ball”, 2 occurrences of the word “sports”, 2 occurrences of the word “points” and 4 occurrences of the word “win”.

The dashed lines connecting Document #1 (921) and Document #2 (922) to Cluster D Prototype (961) indicate that these two documents are in this cluster. The left hierarchy, Hierarchy 1, uses the “ball” dimension and “sports” dimension of the input documents to cluster them. Each cluster prototype of this hierarchy (931, 941, 951, 961, 971, 981, 991) has a value for “ball” that is the average “ball” value of the documents of which it is an ancestor. Each cluster prototype of this hierarchy (931, 941, 951, 961, 971, 981, 991) also has a value for “sports” that is the average “sports” value of the documents of which it is an ancestor. Thus, Cluster D Prototype (961) has a “ball” value of 4.5 since its two document descendants, #1 & #2 (921, 922), have “ball” values of 4 and 5 respectively, and (4+5)/2=4.5. Cluster D Prototype (961) has a “sports” value of 10 since its two document descendants, #1 & #2 (921, 922), have “sports” values of 10 and 10 respectively, and (10+10)/2=10.

Cluster E Prototype (971) has a “ball” value of 2 since its two document descendants, #3 & #4 (923, 924), have “ball” values of 2 and 2 respectively, and (2+2)/2=2. Cluster E Prototype (971) has a “sports” value of 7.5 since its two document descendants, #3 & #4 (923, 924), have “sports” values of 8 and 7 respectively, and (8+7)/2=7.5.

Cluster F Prototype (981) has a “ball” value of 6 since its two document descendants, #5 & #7 (925, 927), have “ball” values of 6 and 6 respectively, and (6+6)/2=6. Cluster F Prototype (981) has a “sports” value of 2.5 since its two document descendants, #5 & #7 (925, 927), have “sports” values of 3 and 2 respectively, and (3+2)/2=2.5.

Cluster G Prototype (991) has a “ball” value of 9.5 since its two document descendants, #6 & #8 (926, 928), have “ball” values of 10 and 9 respectively, and (10+9)/2=9.5. Cluster G Prototype (991) has a “sports” value of 2.5 since its two document descendants, #6 & #8 (926, 928), have “sports” values of 3 and 2 respectively, and (3+2)/2=2.5.

The thick lines connecting Document #1 (921) and Document #7 (927) to Cluster K Prototype (962) indicate that these two documents are in this cluster. The right hierarchy, Hierarchy 2, uses the “points” dimension and “win” dimension of the input documents to cluster them. Each cluster prototype of this hierarchy (932, 942, 952, 962, 972, 982, 992) has a value for “points” that is the average “points” value of the documents of which it is an ancestor. Each cluster prototype of this hierarchy (932, 942, 952, 962, 972, 982, 992) also has a value for “win” that is the average “win” value of the documents of which it is an ancestor. Thus, Cluster K Prototype (962) has a “points” value of 9.5 since its two document descendants, #1 & #7 (921, 927), have “points” values of 10 and 9 respectively, and (10+9)/2=9.5. Cluster K Prototype (962) has a “wins” value of 7.5 since its two document descendants, #1 & #7 (921, 927), have “win” values of 7 and 8 respectively, and (7+8)/2=7.5.

Cluster L Prototype (972) has a “points” value of 6 since its two document descendants, #3 & #5 (923, 925), have “points” values of 6 and 6 respectively, and (6+6)/2=6. Cluster L Prototype (972) has a “wins” value of 9.5 since its two document descendants, #3 & #5 (923, 925), have “win” values of 9 and 10 respectively, and (9+10)/2=9.5.

Cluster M Prototype (982) has a “points” value of 5.5 since its two document descendants, #2 & #4 (922, 924), have “points” values of 5 and 6 respectively, and (5+6)/2=5.5. Cluster M Prototype (982) has a “wins” value of 2.5 since its two document descendants, #2 & #4 (922, 924), have “win” values of 2 and 3 respectively, and (2+3)/2=2.5.

Cluster N Prototype (992) has a “points” value of 2.5 since its two document descendants, #6 & #8 (926, 928), have “points” values of 3 and 2 respectively, and (3+2)/2=2.5. Cluster N Prototype (992) has a “wins” value of 4.5 since its two document descendants, #6 & #8 (926, 928), have “win” values of 5 and 4 respectively, and (5+4)/2=4.5.

Cluster B (941) is the ancestor of Cluster D (961) and Cluster E 971. Cluster B (941) is also the ancestor of those documents that are descendants of the clusters that are its descendants. This means that Cluster B (941) is an ancestor of documents #1 and #2 (921, 922) because these documents are descendants of Cluster D (961) and Cluster D (961) is a descendant of Cluster B (941). This also means that Cluster B (941) is an ancestor of documents #3 and #4 (923, 924) because these documents are descendants of Cluster E (971) and Cluster E (971) is a descendant of Cluster B (941). A cluster that is the parent of other clusters uses the same dimensions as those of its children. In the case of Cluster B Prototype (941) these dimensions are the same as those used by Cluster D Prototype (961) and Cluster E Prototype (971), namely dimensions “ball” and “sports”. The value for these dimensions can be calculated either as the average of all the documents for which it is an ancestor, or as the average of the values of all the descendent clusters in the same Tier. In the case of Cluster B Prototype (941), The Tier 2 clusters that are its descendants comprise cluster D Prototype (961) and Cluster E Prototype (971), and therefore their values can be averaged to more easily calculate the prototype values for Cluster B Prototype (941). Thus, Cluster B Prototype's (941) “ball” value is 3.25 since Cluster Prototypes D and E (961, 971) have “ball” values 4.5 and 2 respectively, and (4.5+2)/2=3.25. Cluster B Prototype's (941) “sports” value is 8.75 since Cluster Prototypes D and E (961, 971) have “sports” values 10 and 7.5 respectively, and (10+7.5)/2=8.75.

In the case of Cluster C Prototype (951), The Tier 2 clusters that are its descendants comprise cluster F Prototype (981) and Cluster G Prototype (991), and therefore their values can be averaged to more easily calculate the prototype values for Cluster C Prototype (951). Thus Cluster C Prototype's (951) “ball” value is 7.75 since Cluster Prototypes F and G (981, 991) have “ball” values 6 and 9.5 respectively, and (6+9.5)/2=7.75. Cluster C Prototype's (951) “sports” value is 2.5 since Cluster Prototypes F and G (981, 991) have “sports” values 2.5 and 2.5 respectively, and (2.5+2.5)/2=2.5.

Cluster I (942) is the ancestor of Cluster K (962) and Cluster L (972). Cluster I (942) is also the ancestor of those documents that are descendants of the clusters that are Cluster I's (942) descendants. This means that Cluster I (942) is an ancestor of documents #1 and #7 (921, 927) because these documents are descendants of Cluster K (962) and Cluster K (962) is a descendant of Cluster I (942). This also means that Cluster I (942) is an ancestor of documents #3 and #5 (923, 925) because these documents are descendants of Cluster L (972) and Cluster L (972) is a descendant of Cluster I (942). A cluster that is the parent of other clusters uses the same dimensions as those of its children. In the case of Cluster I Prototype (942) these dimensions are the same as those used by Cluster K Prototype (962) and Cluster L Prototype (972), namely dimensions “points” and “win”. The value for these dimensions can be calculated either as the average of all the documents for which it is an ancestor, or as the average of the values of all the descendent clusters in the same Tier. In the case of Cluster I Prototype (942), the Tier 2 clusters that are its descendants comprise cluster K Prototype (962) and Cluster L Prototype (972), and therefore their values can be averaged to more easily calculate the prototype values for Cluster I Prototype (942). Thus Cluster I Prototype's (942) “points” value is 7.75 since Cluster Prototypes K and L (962, 972) have “points” values 9.5 and 6 respectively, and (9.5+6)/2=7.75. Cluster I Prototype's (942) “win” value is 8.5 since Cluster Prototypes K and L (962, 972) have “win” values 7.5 and 9.5 respectively, and (7.5+9.5)/2=8.5.

In the case of Cluster J Prototype (952), The Tier 2 clusters that are its descendants comprise cluster M Prototype (982) and Cluster N Prototype (992), and therefore their values can be averaged to more easily calculate the prototype values for Cluster J Prototype (952). Thus Cluster J Prototype's (952) “points” value is 4 since Cluster Prototypes M and N (982, 992) have “points” values 5.5 and 2.5 respectively, and (5.5+2.5)/2=4. Cluster J Prototype's (952) “win” value is 3.5 since Cluster Prototypes M and N (982, 992) have “win” values 2.5 and 4.5 respectively, and (2.5+4.5)/2=3.5.

Similar to how we calculated the dimensions and values of Tier 1 Cluster Prototypes (941, 951, 942, 952), we can calculate the dimensions and values of the Tier 0 Cluster Prototypes (931, 932). Cluster A Prototype (931) uses the “ball” and “sports” dimensions utilized by its descendant clusters (941, 951, 961, 971, 981, 991), and can take the value of the average of the Tier 1 Clusters that are its descendants, namely Cluster Prototypes B and C (941, 951). Thus, Cluster A Prototype (931) has a “ball” value of 5.5 since Cluster Prototypes B and C (941, 951) have “ball” values of 3.25 and 7.75 respectively, and (3.25+7.75)/2=5.5. Cluster A Prototype (931) has a “sports” value of 5.625 since Clusters B and C (941, 951) have “sports” values of 8.75 and 2.5 respectively, and (8.75+2.5)/2=5.625.

Cluster H Prototype (932) uses the “points” and “win” dimensions utilized by its descendant clusters (942, 952, 962, 972, 982, 992), and can take the value of the average of the Tier 1 Clusters that are its descendants, namely Cluster Prototypes I and J (942, 952). Thus, Cluster H Prototype (932) has a “points” value of 5.875 since Cluster Prototypes I and J (942, 952) have “points” values of 7.75 and 4 respectively, and (7.75+4)/2=5.875. Cluster H Prototype (932) has a “win” value of 6 since Clusters I and J (942, 952) have “win” values of 8.5 and 3.5 respectively, and (8.5+3.5)/2=6.

Although Hierarchy 1 and Hierarchy 2 do not share input dimensions it is possible that they share some input dimensions and keep some unique. It is also possible that they share all input dimensions and differ only in the clustering algorithm. Although the examples of this and previous figures utilize two input dimensions per hierarchy it is possible for a hierarchy to cluster its inputs along hundreds, thousands, millions, or more dimensions. In one common scenario most of the dimensions contain zero values for most of the inputs. This is called a sparse representation and the zero values can be stored more efficiently by simply noting which dimensions are nonzero rather than listing all of the zero dimensions. This technique is often used to save memory. Although measuring the distance between two vectors with dense representations (where the zero values and non-zero values do not differ in the means by which they are stored) is compatible with SIMD architectures for improved performance, the sparse representations may benefit from hardware that does not implement SIMD but has improved sparse memory lookups as well as improved unpredictable branching (such as with a short pipeline, or a pipeline whose ill branching effects are countered by multithreading of the pipeline) and/or conditional data movement operations. Thus some hierarchies may be best calculated on certain architectures, while other hierarchies will benefit from execution on different hardware. This circumstance will be illuminated in subsequent figures.

Hierarchies may also use the cluster information of other hierarchies as input, such that the input dimension is specific to the hierarchy and tier of the cluster, and the specific cluster within that tier holds the value of that dimension. Distances between values in this dimension can be calculated and integrated into an overall distance calculation between data and data, or data and prototypes using various techniques. This will also be illuminated in subsequent figures. Although two hierarchies are listed in the example of this figure, dozens, hundreds, thousands, millions, or more hierarchies might be implemented, especially during the search for which hierarchies are most useful. We will show an automatic method of determining which hierarchies are useful, which can make the instantiation of a large number of hierarchies useful.

Finally, a unit of code implementing an algorithm that organizes data hierarchically may receive as input the raw data associated with each input element and may translate this to spatial coordinates or some other representation internally. In this preferred embodiment it may be the case that no other hierarchies are able to utilize any of the input dimensions utilized by that unit of code. In another preferred embodiment, said unit of code may provide the input dimensions to only those other units of code that are sold by the same vendor, such that the input dimensions are kept private to the vendor that has created said unit of code. In this way a vendor may keep private both the algorithm used to organize data hierarchically, and the mapping of data to dimensions used by that algorithm, such that the vendor may charge a fee relative to the total advantage that the input dimensions and algorithm provide in concert.

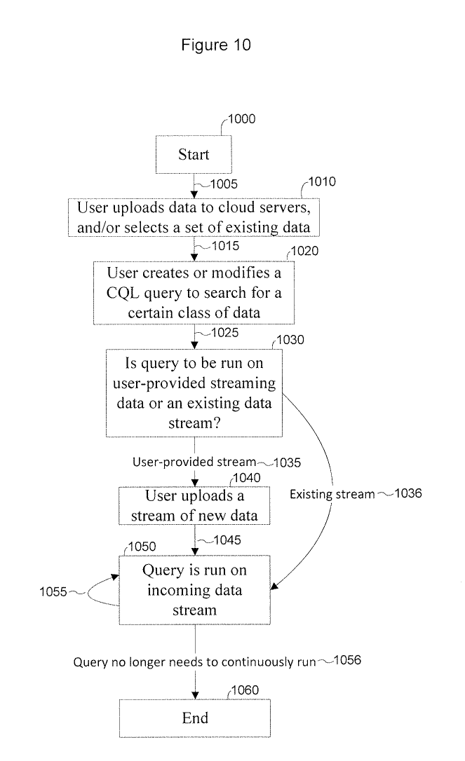

FIG. 10 depicts the high level process through which a user can create a CQL query and run it. The process starts at the “Start” step (1000). The process proceeds immediately via link 1005 to step “User uploads data to cloud servers, and/or selects a set of existing data” (1010). In this step the user sets the CQL system up with the data that will be used for the CQL query by either selecting an existing stream or uploading the stream that is not already uploading. Alternatively the user may upload a batch of data that is not streaming, or selects an existing batch. This is the data that will be used to build the CQL query. The process then proceeds immediately to step 1020 via link 1015.

In step 2020 the “User creates or modifies a CQL query to search for a certain class of data”. This can be performed through a process with an interactive CQL query builder (420), which will be described in a subsequent diagram. This process can use the data uploaded or selected in step 1020. Once the CQL system has the query loaded and the user has designated that they would like to run it, the process proceeds immediately to step 1030 via link 1025.

In step 1030 the process branches based on the result to the following question: “Is the query to be run on user-provided streaming data or an existing data stream?”. If the query is to be run on a user-provided stream that is not already loading, then the process proceeds via the “User-provided stream” link (1035) to step 1040. If an existing stream (already uploading) is to be used then the process proceeds via the “Existing stream” link (1036) to step 1050.

In step 1040 the “User uploads a stream of new data”. This data will be processed in real time by the query that was developed and/or designated in step 1020. In other words, in step 1050 the data uploaded in step 1040 will be processed by said query as it is uploaded. Step 1040 proceeds immediately to step 1050 via link 1045.

In step 1050 the “Query is run on incoming data stream”. The query that is run is the query or queries that were developed and/or designated in step 1020. The stream that is processed in real time by this query is the stream designated in step 1030 (in the case that it was a pre-existing stream) or that began uploading in step 1040 (in the case that it required new uploading). The query or queries are continuously run on the incoming data stream as a result of the default repetition of step 1050 via traversal of link 1055. In the case that the “Query no longer needs to continuously run” (1056) the process proceeds via link 1056 to the “End” step (1060).

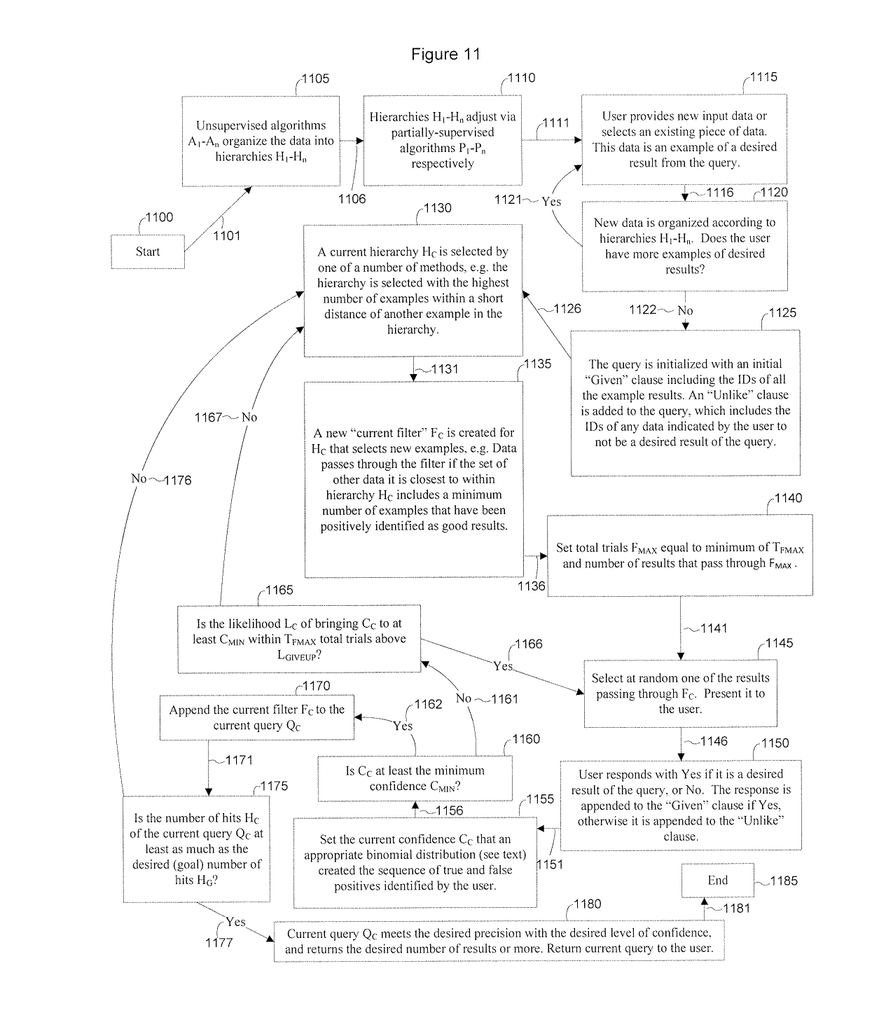

FIG. 11 depicts a preferred embodiment of the process through which the Interactive Query Builder 420 constructs CQL queries through interaction with a user. The process starts at Step 1100, which proceeds immediately to step 1105 via link 1101. Step 1105 is the “Unsupervised algorithms A₁-Aₙ organize the data into hierarchies H₁-Hₙ” step. In this step a number of hierarchies H₁-Hₙ are constructed using a number of unsupervised algorithms A₁-Aₙ. In one preferred embodiment a Filter Builder chooses what hierarchies should be constructed and what unsupervised algorithms should be used to construct them based on what kinds of hierarchies have been previously successful in scenarios like the current user scenario (this is described in a subsequent diagram). In one embodiment, hierarchies such as those depicted in FIG. 9 comprise some of the hierarchies constructed during this step. This step proceeds to step 1110 via link 1106.

Step 1110 is the “Hierarchies H₁-Hₙ adjust via partially-supervised algorithms P₁-Pₙ respectively” ” step. In this step any supervised information is integrated into the hierarchy organization so that data of the same category tends to be clustered together at the higher tiers of the hierarchies, and data of different categories is made to be or remains in separate clusters. If the supervised data is designated by the user to not be relevant to the query under construction then this optimization does not occur. In the common cases that are anticipated there is little or no relevant supervised data, however it is important that this step integrate such information if it is available. Such information might come from previous queries that have been built by this same user or by other users using the same input data. In this way users can leverage each other's query building to improve their own query building, which may prove to be essential under circumstances where the interactive query builder would otherwise require a lengthy process that results in low quality queries. This step proceeds to step 1115 via link 1111.

Step 1115 is the “User provides new input data or selects an existing piece of data. This data is an example of a desired result from the query” step. In this step the user provides an example that would be a good result from the query. This interaction allows the user to build the query using examples instead of by programming, since programming skills require special training to develop, or bringing an engineer on staff that has undergone this special training. This step proceeds to step 1120 via link 1116.

Step 1120 is the “New data is organized according to hierarchies H₁-Hₙ. Does the user have more examples of desired results?” step. In this step the hierarchies are generally not reorganized unless multiple examples have been produced by the user (i.e. step 1115 has executed at least twice). Once the system has multiple good examples of the query results, the hierarchies can be sorted by their intrinsic utility in clustering the positive examples together. For example, if three positive examples have been found, a hierarchy that has these three examples clustered together in a cluster that has a total of only four examples, the cluster is already very similar to what the user would consider a good classifier for the query, and the fourth piece of data in the cluster is a good candidate for being a positive example of data that should pass through the filter (query). Clusters of sizes that hint at good utility tend to contain more positive examples than would be expected by random selection. Hierarchies that appear to have low utility (i.e. hierarchies that cluster together the positive examples with random-like probability_can be recognized such and may be fixed by changing the input dimensions they examine, pruning the hierarchy, or changing its branching factor, etc. This step proceeds either via the “yes” link 1121 to step 1115 (in the case that the user has more positive examples to present the system), or via the “no” link 1122 to step 1125.

Step 1125 is the “The query is initialized with an initial “Given” clause including the IDs of all the example results. An “Unlike” clause is added to the query, which includes the IDs of any data indicated by the user to not be a desired result of the query” step. In this step the positive and negative examples that have been provided by the user are included in the CQL query text or its data structure and become intrinsic to the query. In a preferred embodiment, the “Given” and “Unlike” clauses of the CQL query are the only parts of the query that are outside the classic SQL syntax. They may be surrounded by comment symbols, such as curly braces “{ }” so that they do not violate the SQL syntax. This step proceeds to step 1130 via link 1126.

Step 1130 is the “A current hierarchy H_{C} is selected by one of a number of methods, e.g. the hierarchy is selected with the highest number of positive examples that are within a short distance (hierarchy path through closest shared ancestor) of another positive example” step. In one embodiment this step includes sorting of the hierarchies such that the hierarchy most likely to find a new positive example near multiple already-found positive examples is at the front of the hierarchy list. The front of this list indicates the hierarchy with the highest priority for integration into the query (i.e. the hierarchy that appears most promising in aiding the query builder towards achieving its goals). Indeed sorting may require far more computation than is actually necessary to obtain the hierarchy with the most promising organization, since it is not necessary that the least and second least promising hierarchies be identified and precisely ordered relative to each other. A Top-1 or Top-N sort may suffice such that sorting only occurs for those hierarchies that remain current candidates to be placed in the Top-1 (meaning only the most promising hierarchy is sorted and thus does not actually require a sort since it must only be sorted with itself) or Top-N respectively.

Negative examples may also be used to select the most promising hierarchies, or to eliminate otherwise promising hierarchies from consideration. For example, hierarchies that organize multiple positive examples into reasonably tight clusters would be considered promising, however, if this tight clustering includes negative examples, or includes more than a threshold number of negative examples, then the hierarchy may not be deemed promising. In one embodiment this negative example threshold is a percentage of the number of examples that have been found to be tightly clustered in the hierarchy. In another embodiment the threshold may be set higher or lower depending on what the user has determined to be the desired precision (probability the query returns positive results). This step proceeds to step 1135 via link 1131.

Step 1135 is the “A new “current filter” F_{C} is created for H_{C} that selects new examples, e.g. Data passes through the filter if the set of other data it is closest to within hierarchy H_{C} includes a minimum number of examples that have been positively identified as good results.” step. In this step the aspect of hierarchy He that caused it to be deemed promising in step 1130 is used to create a new filter. In one embodiment the selection of the hierarchy was not definitive and in step 1130, such as if too few examples have been presented by the user to allow the hierarchies to be properly sorted, such as in the case that only one example has been presented. In this case hierarchy H_{C} is re-analyzed so that the aspect of the hierarchy that is most likely to correctly identify results for the query is selected. For example, consider a portion of the hierarchy that clusters data records together where those records cannot be easily compressed. The interactive query building system may use this as an indication that the data in that portion of the hierarchy may be of interest as it may have more information and/or less redundancy. This method also applies to the case where no examples have yet been presented by the user. The opposite method may also be utilized, so that data records that are clustered together and can be easily compressed signals an interesting cluster that may be of use as a component of a user's query. The history of success of using one or both of these techniques, or other information-based techniques, can be utilized whenever the set of positive and negative example data records results in an inconclusive choice for filtering. In another embodiment, a component of a hierarchy may be considered a good candidate for addition to the query as a filter if that hierarchy component, or a similar component in a similarly constructed hierarchy, was used in a previous query that is not known to be related to the current user's query. In this way, as the system searches for the next component of the query being built, it is possible for the system to beat random selection techniques, even in the absence of information specific to the current query. This step proceeds to step 1140 via link 1136.

Step 1140 is the “Set total trials F_{MAX} equal to minimum of T_{FMAX} and number of results that pass through F_{MAX}.” step. In this step the maximum number of trials that will be used to test the current filter, F_{MAX}, is determined. Since the total number of trials cannot be larger than the number of unknown data that are returned by the filter, this is set as an upper bound. Another upper bound for this value is set as the maximum number of trials that should be necessary to determine if a filter is a reasonable addition to a query, which is defined as the T_{FMAX value}. The T_{FMAX} value may be set by the user or learned by the interactive CQL query builder (420) through previous interactive sessions. Previous interactive sessions that were recorded in the context of the current input data that is to be processed may be used to produce a T_{FMAX} value by determining how often a filter became useful after a given number of interactions. Setting the T_{FMAX} value such that all or nearly all of these filters would still be discovered as useful is one technique for deriving the T_{FMAX} value. This step proceeds to step 1145 via link 1141.

Step 1145 is the “Select at random one of the results passing through F_{C}. Present it to the user.” step. In this step the system selects an instance of data that passes through the current filter in order to present it to the user and determine if it is indeed a positive example. This step proceeds to step 1150 via link 1146.

Step 1150 is the “User responds with Yes if it is a desired result of the query, or No. The response is appended to the “Given” clause if Yes, otherwise it is appended to the “Unlike” clause.” step. Positive examples are recorded intrinsically in the query so that the current state of a CQL query aids in its own refinement and improvement. The “Given” clause, which may also be referred to as the “Like” clause, maintains positive examples of data that is desired to be returned by the query (i.e. pass through the filter), The “Unlike” clause of the CQL query maintains a list of results that are known to not be positive examples for the query. In one embodiment the user may also interact through an interface including responses of “Very Like”, “Like”, “Unlike”, and “Very Unlike” so that examples that are reasonably positive examples are separated from prototypical examples, and the same data collection is performed for negative examples (i.e. bad but not terrible examples are maintained in the “Unlike” clause, and the “Very Unlike” clause maintains the list of data that are detrimental to the system if they are returned by the query). If more than “Like” and “Unlike” clauses are included in the query building process then the system may be optimized to take into account this softer classification system. Such a classification system is anticipated to be better suited to queries where it is reasonable to return false positives of certain types but not of other types. In order to maintain SQL compatibility with the query, the CQL query may be stored in a form that is CQL-specific but capable of generating an SQL-compatible query, or it may be stored such that the non-SQL-compatible clauses are held in commented sections of the SQL query so that they do not conflict with the SQL syntax and therefore the CQL query is maintained in SQL-compatible form. When the sender of a CQL query and the receiver both know that certain clauses are not needed by the receiver or downstream systems, then the sender may opt to not send those clauses that are unnecessary in order to more efficiently send SQL queries as messages, thereby enabling message passing with reduced bandwidth and lower total latency. This step proceeds to step 1155 via link 1151.

Step 1155 is the “Set the current confidence C_{C} that an appropriate binomial distribution (see text) created the sequence of true and false positives identified by the user.” step. In this step the probability that the current filter should be added to the current query is calculated. An “appropriate” binomial distribution is one with a p-value (elemental probability of success) at least as high as the minimum precision selected by the user. The minimum precision that is allowable by the user is related to the maximum percentage of false-positives that are allowable (the probability of a false positive is one minus the precision). The binomial distribution formula simulates probability of selecting X positive examples out of Y trials from a vessel holding positive and negative examples when the probability of choosing a positive example is in any individual trial is p. This maps to the current vetting process (step 1150) such that the number of positive examples the user has identified for the current filter in step 1150 is X, the total number of times step 1150 has been visited for the current filter is Y. We do not know the true probability p unless we test all of the data records that pass through the filter. We can use the binomial formula to calculate the probability of X given Y and p. If we set the value p to the minimum precision allowable by the user (which is related to the maximum tolerable false positive rate) then we can calculate the probability that the current filter has a p value at least as high as the minimum desired precision. In fact the cumulative binomial distribution function is able to calculate the probability that x or fewer positive examples would have been found, and one minus this value is the probability that at least x+1 values would be found. We can calculate the desired value (the probability that at least the actual number of positive examples that were found would have bee found) as one minus the cumulative distribution function calculated on a value X that is one less then the number of positive examples we have found so far. A number of methods exist for calculating bounds on the value of the cumulative distribution function, and table methods can be employed for a small number of trials, which is the case when the user's time is being optimized for (very many trials would be too cumbersome for the user and therefore an unrealistic use case for the novel system).

In this way we calculate the probability that a faith in the precision of the current filter being as good as the goal precision would be well placed. In other words, it is possible that positive examples that have been identified by the user from the output of the current filter were accidental and not indicative that the filter is good at finding positive examples. The hypergeometric distribution (and its cumulative hypergeometric distribution function) is generally a more accurate estimator of the probabilities we desire to calculate in step 1155 because our presentation of data records to the user is generally “without replacement”. It is “without replacement” because we will not present the same data record to the user after they have already said whether the data record is a positive or negative example of the current query. Thus the use of the hypergeometric distribution is preferred however the binomial distribution is typically a reasonable estimate and may be preferred in certain instances such as when simpler formulas and calculations are desired. Furthermore, what constitutes a simpler formula or calculation is dependent on the software and hardware implementation and should be taken into account when selecting the binomial or hypergeometric functions. The hypergeometric function may introduce inaccuracy due to the fact that the precision of the filter on the initially uploaded input data is not the precision that the filter will have on the streaming data that will be presented later. Thus, the binomial distribution may have a built-in hedge against overly extrapolating from the development input data to the streaming data. The probability calculation in this step determines the level of confidence that should be placed in the filter that is currently under examination being sufficiently precise. This step proceeds to step 1160 via link 1156.

Step 1160 is the “Is C_{C} at least the minimum confidence C_{MIN}?” step. In this step the probability/confidence value C_{C} that was calculated in step 1155 is compared to a minimum confidence value to determine whether the filter is above the confidence threshold for addition to the query. This step proceeds either via “No” link 1161 to step 1165 (in the case that the threshold was not met), or via “Yes” link 1162 to step 1170 (in the case that the threshold of confidence has indeed been met).

Step 1165 is the “Is the likelihood L_{C} of bringing C_{C} to at least C_{MIN} within T_{FMAX} total trials above L_{GIVEUP}?” step. In this step the confidence, which has been found to not be sufficient to add the current filter to the query without further interaction, is processed with respect to all of the user interactions that have been performed using this filter and all that might still be performed. If it is determined that it is unlikely (or likelihood L_{C} is below a certain threshold L_{GIVEUP}) that the current filter will be found to be of sufficient quality within the maximum number of interactions to be allowed T_{FMAX}, then the process proceeds via “No” link 1167 to step 1130. If the process determines that the likelihood L_{C} of identifying the current filter as worthy of addition to the query is sufficiently high within the maximum number of interactions T_{FMAX} that have been previously determined (step 1140), then the process proceeds via “Yes” link 1166 to step 1145. In one embodiment a single negative feedback by the user is sufficient to cause abandonment of the current filter, and a single positive example is enough to allow its inclusion. One example where a single positive example is sufficient for inclusion is if the filter only allows a single value (or very few values) from the initial data upload to pass through. In one preferred embodiment a minimum number of user interactions per filter is used in the low-information cases where the likelihoods are being calculated from very few user interactions with the current filter. For example, the formulas might suggest that one positive and one negative example indicate a sufficiently low likelihood L_{C} such that the filter should be given up on, and in this instance a minimum user interaction rule may be enacted for the specific case of one positive and one negative example for the given desired precision so that the current filter is not yet given up on.

Step 1170 is the “Append the current filter F_{C} to the current query Q_{C}” step. In this step the filter is added to the current query so that results that pass through this filter (or are labeled as “passing” through the filter) will also pass (or be labeled as passing) through the query. Step 1170 is reached when the user interactions have indicated that the precision of the current filter is at least as high as the minimum allowable precision. In another preferred embodiment, certain clauses with precision almost as high as the desired precision are maintained as optional clauses for the query that may be added to the query in subsequent configuration. Such clauses may be integrated into the query in the case that a set of clauses is found have precision higher than necessary, so that when the optional clauses are combined with set of high precision clauses the total precision is maintained above the minimum allowable precision. This step proceeds to step 1175 via link 1171.

Step 1175 is the “Is the number of hits He of the current query Q_{C} at least as much as the desired (goal) number of hits H_{G}?” step. In this step the user is sent through the process of adding filters to the query until the desired number of results is achieved. In other words, filters of sufficient quality, with sufficiently high precision, are added to the query until enough results pass through the filter. The hits used in this step may either be calculated as true positives or as the sum of true and false positives. In the case where the user has a good estimate of the number or percent of examples that are positives then the hits may be calculated as the number of true positives so that the goal of the query is to find all or nearly all of the positive examples in the data. In the case that there is a limited amount of processing power for handling data records that pass through (or are labeled as passing through) the query then the number of hits may be calculated as the sum of the false positives and true positives, so that the total number of records identified by the system as positive is kept below some maximum number that can be processed.

In mathematical terms the query is like the disjunction of multiple clauses, where passage through any one clause is sufficient to pass through the entire query. In Boolean algebra this is called disjunctive normal form. In one embodiment, achievement of any clause that has sufficient precision may take most or all of the time that the system interacts with the user, and the discovery of any such clause is sufficient to make the query of sufficient quality. For example, a query that finds a very rare piece of data, but that data has extremely high signal for predicting a future outcome, may be sufficient to make the query useful on its own without additional clauses/filters added by means of disjunction. This step proceeds either via “No” link 1176 to step 1130, or via “yes” link 1177 to step 1180.

Step 1180 is the “Current query Q_{C} meets the desired precision with the desired level of confidence, and returns the desired number of results or more. Return current query to the user” step. In this step the query is returned to the user. This may also involve the storage of this query into a repository so that it can be loaded by the CQL system easily in the future, such as for processing a new input stream, for improvement via further interaction with the user, or for use by other users through the sale of its use by the user that originally created it. In step 1180 the user may also be presented with an option to enable the sale of the query, and, in this case, the user may also be presented with a number of possible fees to choose from. The interactive CQL query builder (420) may estimate which fees would deliver the best return for the user based on the fees of queries that have performed similar to how the user's new query is anticipated to perform. This estimate may be adjusted based on how the current fees being paid on the novel system relate to those that were previously recorded (e.g. to adjust for inflation or other market factors). This step proceeds to the “End” step 1185 via link 1181.

Step 1185 is the “End” step designating the end of the process of FIG. 11, which is performed by the interactive CQL query builder (420). Alternatively, the “End” step 1185 designates the logical conclusion of an iteration of a meta-process performing multiple iterations over the process depicted in FIG. 11.

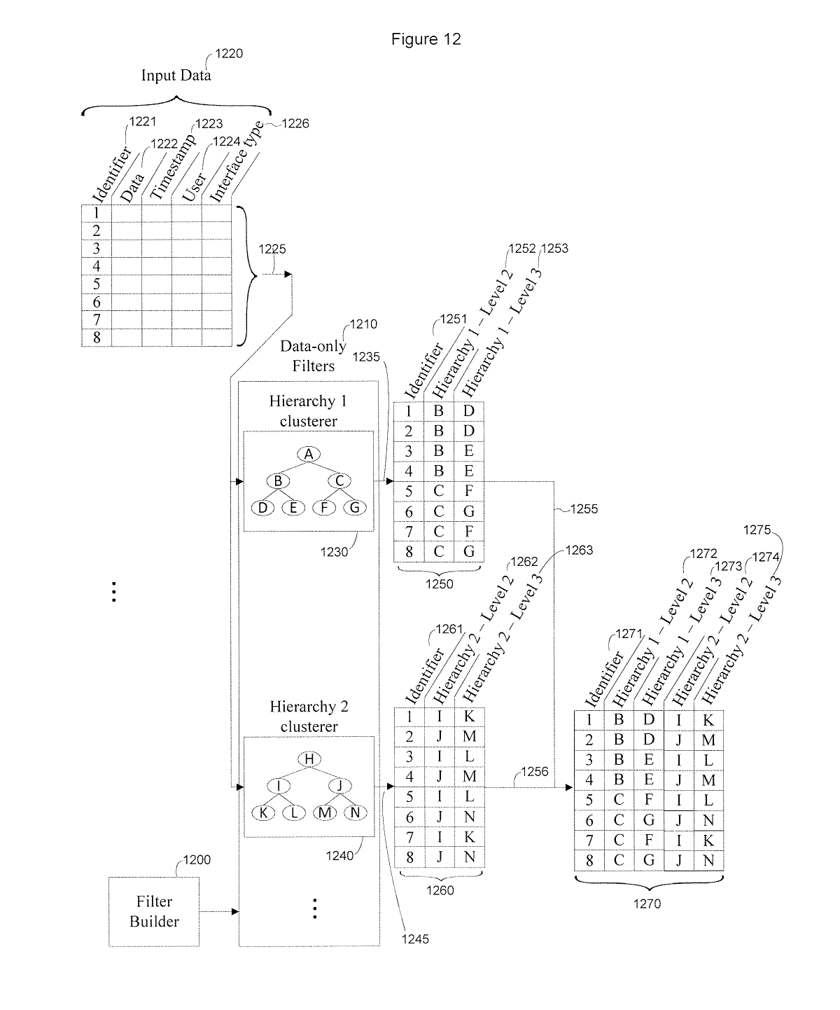

FIG. 12 depicts the process by which Hierarchies (1230, 1240) act as filters (1210) that add column information (1252, 1253, 1262, 1263) to Input Data 1220. The Filter Builder (1200) constructs a set of data-only Filters (1210). The term “data-only”, which we term synonymously with “input-data-only”, means that they do not require information from other filters in order to process the input, meaning that they only require the input data (1220) and not output data (e.g. 1235, 1245) from other filters. Another way to describe this concept is that these filters only require “unstructured data” and do not require structured data, although what structure exists in the input data may also be utilized by the data-only filters (1210). The hierarchies (1230, 1240) could be the same as those from previous figures, such as Hierarchy 1 (e.g. 941, 951, 961, 971, 981, 991) or Hierarchy 2 (932, 942, 952, 962, 972, 982, 992) from FIG. 9 respectively. The “Data” portion (1222) of the Input Data (1220), which signifies the unstructured data portion, is transferred via link 1225 to the data-only filters (1210), although structure data such as the “User” column (1224) may also be transferred via link 1225 to the data-only filters (1210). Here the hierarchies (1230, 1240) that have been constructed by the Filter Builder (1200) categorize the input according to the hierarchical organization that is specific to each hierarchy. This process assigns a particular cluster from each Tier in each hierarchy until an end cluster (also termed a “leaf cluster” in a hierarchy) has been assigned from each hierarchy to the data. In one preferred embodiment the input data (1220) is compared only to the leaf clusters in a hierarchy and the clusters associated with the input data (1220) from the other hierarchy tiers are inferred from the leaf cluster that is found to be most closely related.

The Input Data (1220) is comprised of multiple separate data records, which are rows in the grids of FIG. 12. Each record is described in the diagram by a unique Identifier (1221). Each record has some information related to it that is structured, such as the Timestamp (1223), which may record the time at which the data arrived in the system. The User column (1224) may be used to store the author of the data record, such as the original user (1224) that created the tweet if the Input Data (1220) represents tweets. The Interface type column (1226) may be used to describe the interface through which the user submitted the tweet to the system, in the case that the Input Data (1220) represents tweets.

FIG. 12 further shows that key information regarding how a hierarchy organizes its input data can be stored as additional column information. Thus, while the term “filter” implies that only certain data pass through, the hierarchies (1230, 1240) that act as filters in the novel system add column information to their inputs and do not inherently prevent data from passing through. Downstream systems may use the column information to filter the data, such as by only allowing data from a specific cluster to pass through, but this is not inherent to the hierarchically organizing filters. Such downstream systems may only allow data to pass through if it has a specific value in a specific column, meaning that the data is associated with a specific cluster in a specific hierarchy at a specific tier in that hierarchy. In the novel system, the filters (1230, 1240) add structured data (column data) that can be understood and processed by traditional query languages such as SQL queries. The structured data is extracted by the hierarchies from the unstructured portion of data, possibly in conjunction with some pre-existing structured data (such as Timestamp 1223).

Hierarchy 1 clusterer (1230) outputs via link 1235 the clusters that it has assigned using its internally stored hierarchy. The Input Data (1220) with a given Identifier (1221) maintains that same Identifier value (1251) in the output (1235). For data with a given Identifier (1251), the unstructured data (1222) that was associated with it has been processed by the Hierarchy 1 clusterer (1230) such that a cluster at each tier of Hierarchy 1 has been assigned to the data. We can see that the data record with Identifier 1251 equal to 1 has been assigned Hierarchy 1—Level 2 (1252) value of B, and a Hierarchy 1—Level 3 (1253) value of D. This example can be understood as a continuation of the example of FIGS. 5-9, where each record's (row's) Identifier (1221, 1251, 1261, 1271) has the same value as the document number it represents from FIGS. 5-9. Whereas document #1 was in cluster D (961) and cluster B (941) in Hierarchy 1, and cluster K (962) and cluster I (942) in Hierarchy 2, the data record #1 has a Hierarchy 1—Level 3 (1253) column value of D, a Hierarchy 1—Level 2 (1252) column value of B, a Hierarchy 2—Level 3 (1263) value of K, and a Hierarchy 2 Level 2 (1262) value of 1. These column values are means of storing how each hierarchy categorizes each data record. These column values are understandable by other data processing systems such as spreadsheets and by traditional relational databases such as SQL databases. Once Hierarchy 1 Clusterer (1230) and Hierarchy 2 Clusterer (1240) output their assigned column values (1252, 1253, and 1262, 1263 respectively) via links 1235 and 1245 respectively, this data may be combined via links 1255 and 1256 into an aggregated data structure or logical representation (1270) which contains all of the column information gathered for each record so far (1272, 1273, 1274, 1275 corresponding to 1252, 1253, 1262, 1263 respectively). The Data (1222), Timestamp (1223), User (1224), and Interface type (1226) data has not been discarded but is also included in the aggregated data representation (1270), however it is not shown in the diagram of FIG. 12. The adding of structured data to data records while not requiring the discard of previously obtained data allows downstream systems to be flexible in their use of the structured data. This means that the downstream systems can choose to use or not use any of the structured information that has been associated with each data record during the processing that has already been performed. Downstream systems may use both the structured, previously obtained column data, or the newly obtained column data to process the data, and these downstream systems may further add column information. Here “column information” is synonymous with structured data. The “Data” column (1222) is not easily usable by traditional structured data processing systems (such as SQL Database systems), but structured information is extracted from the unstructured “Data” (1222) column during the process depicted in FIG. 12, so that processing systems such as SQL Databases that were designed and optimized to process structured data can process the Input Data (1220) more effectively. In this way, the Data-only Filters (1210) act as an adapter for unstructured Data (1222) to be processed by structured data (row/column) processors like spreadsheets and SQL databases. Finally, while all of the column information is logically available downstream, systems implementing specific queries may transfer only the column information that will end up being used by a given downstream system to that downstream system. In this way, the bandwidth required to transfer data from the data-only Filters (1210) to the downstream systems is minimized to only that data that might actually be used by said downstream systems. Intermediate systems that aggregate all of the data collected, such as in unit 1270, can also minimize the bandwidth they require for sending data to systems that are downstream from them by restricting the data sent to a downstream system to only the data that may be used by that system. In one example, a downstream filter adds a column value based on the values in two other columns. In this case, only the two columns of data that are used as input by said downstream filter need to be sent to that downstream filter. All of the column data, however, is available to the downstream filter should the downstream filter require it. In another example the downstream filter could change what column data it analyzes within its input data records, and in this case the data that is sent to that downstream filter can change such that it always has the column data it requires, and yet bandwidth requirements for transmission of the data records remain as low as can be.

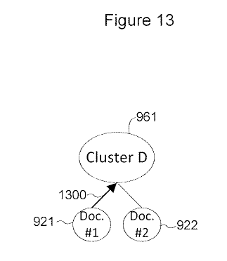

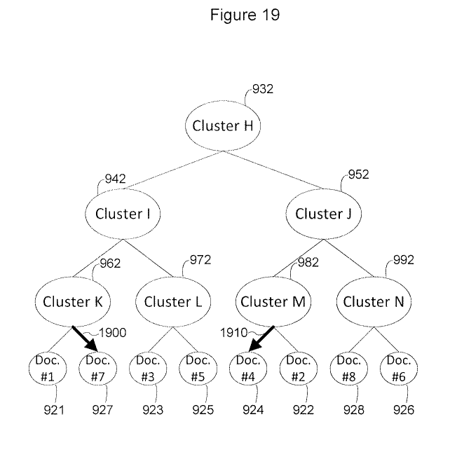

FIG. 13 begins an example walk-through of the process depicted in FIG. 11 whereby the user constructs queries by interacting with the Interactive CQL Query Builder (420). The example walkthrough extends from FIG. 13 through FIG. 19 and utilizes the hierarchies from the example depicted in FIG. 6, FIG. 8, FIG. 9, and FIG. 12. FIG. 13 contains the first step depicted in the series of FIGS. 13 through 19, and this proceeds chronologically through the process until the last depicted step is shown in FIG. 19. It is noteworthy that a downstream filter such as that described previously may receive the assigned cluster information from upstream hierarchies (1230, 1240) and may perform the query that is constructed through the process depicted in FIG. 11. The output of this filter, which is in fact carrying out a CQL Query, may then be another column in the aggregated table similar to table 1270. The column name might be “Query 1”, and if a particular data record passes through the CQL Query named Query 1, then that the Query 1 column will get a “True” value for that data record, otherwise it would get a “False” value. Another means of integrating the results of the interactive CQL Query builder (420) is to create a column for each of the clauses that are joined by disjunction in the complete CQL Query, so that a True/False value is held for each clause of the CQL Query that is being processed by a downstream filter.

At the beginning of the step depicted in FIG. 13 the documents 921-928 have already been organized according to Hierarchy 1 (1230) and Hierarchy 2 (1240). The user has selected document #1 (921) as a positive example of results from the current query, which is a new query under development. Hierarchy 1 is selected by some means (e.g. at random in the case that only one document has been provided by the user as a positive example). The parent cluster of document #1 (921), namely Cluster D (961) is identified by sending signal 1300 upward from the unit representing document #1 (921) in the hierarchy. The goal is to find other documents that are likely to be desirable results for the query under construction.

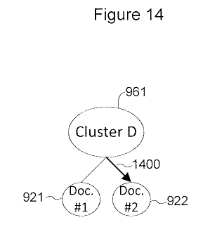

FIG. 14 is the second step in the example process depicted starting in FIG. 13 and ending in FIG. 19. The walkthrough process started in FIG. 13 continues in FIG. 14 with the system searching for a document that is likely to be a desirable result from the current query under construction. Once found, the document will be presented to the user in order to determine whether the document is indeed a positive example. To this end, the nearest cluster parent of the document previously identified as a positive example by the user (Document #1, 921), namely Cluster D (961), logically sends a signal downward toward the documents it contains. Documents that have already been identified by the user as positive or negative examples (or along a more gray scale previously described) are not sent signals, thus only Document #2 (922) is sent signal 1400. An alternative implementation performs a SQL Query on a database holding the information of table 1270 in order to determine which documents receive the logical signal 1400. One document is chosen at random from the set of documents receiving the signal, however in the example depicted in FIG. 14 this comprises only document #2 (922) and so document #2 (922) is selected.

The selected document (document #2, 922) is presented to the user. In this example the user selects the option designating the document as a positive example of desirable results for the current query under construction. The document ID may be added to the “Given” or “Like” clause of the query. In another preferred embodiment all of the child the units of Cluster D (961) receive signals and these units ignore the signals if they have already been presented to the user. In another embodiment the units representing the documents may be distributed across multiple computer processors. Each processor may determine whether it contains the document that will be selected at random by generating a random number. If the distributed processors use the same random number generating algorithm, seed, and remain in synchrony then they will all generate the same random number. This random number can be used to select the document in a distributed fashion. In another preferred embodiment a signal is sent only to the processor that is managing the unit representing the document that is chosen at random. This is another method that may accommodates a distributed processing of the document selection.

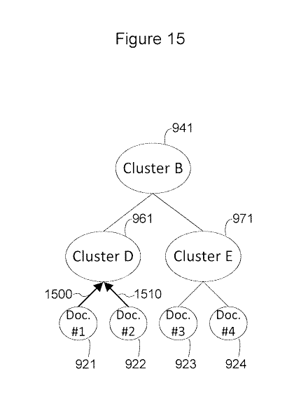

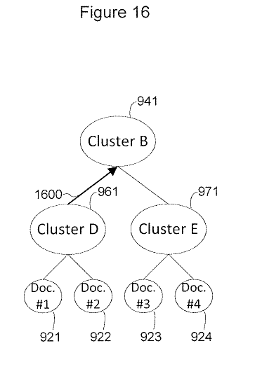

FIG. 15 depicts the third step of the walkthrough that began in FIG. 13. At the beginning of this step documents #1 and #2 (921, 922) have been positively identified by the user as desirable output from the query under construction. The clause that included Hierarchy 1 Level 3 (1273) as a component has 100% precision and is added to the query. It is determined that the desired recall has not yet been reached and so another clause with sufficient precision is sought. Next, the hierarchy most likely to contribute a new clause with sufficient precision is searched for. Since Hierarchy 1 (1230) has both positive examples in a very tight clustering it receives a high score of likelihood to contribute an additional clause to the query. Once Hierarchy 1 (1230) has been selected, Documents #1 and #2 (921, 922) send signals 1500 and 1510 respectively to their nearest parent, which in this case is Cluster D (961). Since Cluster D (961) has no additional child documents that would be useful to prompt the user with, the process proceeds along to the fourth step, which is depicted in FIG. 16.

FIG. 16 depicts the fourth step in the walkthrough example that began in FIG. 13. In this figure a hierarchy sub-component is being searched for that is likely to contribute a clause with sufficient precision to the query under construction. Since Cluster D's (961) children have already been examined by the user, Cluster D (961) sends a logical signal (1600) to Cluster B (941). This logical signal may in fact be carried out by a traditional database query acting on the cluster assignments depicted in table 1270.

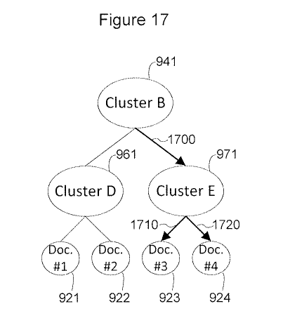

FIG. 17 depicts step 5 in the walkthrough example that began in FIG. 13. A clause that includes documents clustered into Cluster B (941) of Hierarchy 1 (1230) has been determined as worth testing through user interaction. To select a document in this cluster, Cluster B (941) sends logical signal 1700 to its sub-clusters whose documents have not already been examined completely (i.e. not Cluster D 961), namely Cluster E (971). Cluster E (971) then sends logical signals 1710 and 1720 to the documents it contains, which comprise document #3 (923) and document #4 (924) respectively. One of these documents is selected for presentation to the user and the user will determine whether it is or is not a desirable output for the current query under construction. In this example walkthrough Document #3 (923) is selected by the interactive CQL query builder (420), and the user chooses the option designating that it is not a desirable result for the current query. Document #3 (923) is then added to the “Unlike” clause of the current query so that documents that are unlike document #3 (923) have a better chance of becoming results of the query than documents like it. It is determined that the likelihood of that a clause including documents under Cluster B (941) should be added to the query is sufficiently low that this clause is not further pursued, and a new clause is sought. The process depicted in FIG. 11 proceeds in its search for a new clause by estimating which hierarchy is most likely to yield a hierarchy component that successfully filters for desirable outputs. The example walkthrough selects Hierarchy 2 (1240), which in this example is the only other hierarchy besides Hierarchy 1 (1230).

Note that the scale of the example had to be kept small such that it fit in a reasonable number of figures. Discovery of two successful matches in a clause may well be spurious and stronger statistical significance may be needed to justify the addition of a clause. For example, it may be that clauses with fewer than M number of positive examples cannot reach sufficient statistical significance and thus do not merit enquiry in the process performed by the interactive CQL query builder (420).

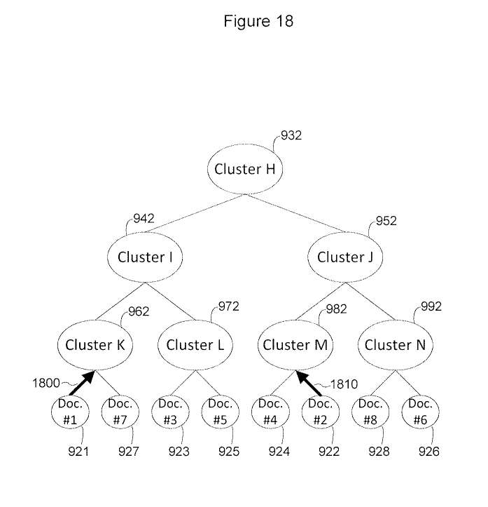

The walkthrough that began in FIG. 13 proceeds from the fifth step depicted in FIG. 17 to the sixth step in FIG. 18.

FIG. 18 depicts step 6 in the walkthrough that started in FIG. 13. The walkthrough is an example operation of the process depicted in FIG. 11 whereby a user interacts with the Interactive CQL Query Builder (420) in order to construct a query with the desired results. Having successfully discovered one clause (including Cluster D, 961) and discovering a clause that was not desirable (Cluster B, 941), the search for additional query clauses has come to Hierarchy 2 (1240). Documents #1 and #2 (921, 922), which have been successfully identified as desirable results for the query, send logical signals to their parent clusters, Cluster K (962) and Cluster M (982) by sending logical signals 1800 and 1810 respectively. As described previously, this process might be performed in practice by a downstream system that uses a table such as table 1270 as input. Selection of whether Cluster K (962) or Cluster M (982) are a good clause to add to the query will be determined in the subsequent step. Note that it is also possible for the negative example documents to send signals, however these signals are logically different form the signals sent by the positive examples. In this way those clusters that have positive example children and no negative example children can be more rapidly identified as good candidates for query clauses.

FIG. 19 depicts the last step in the walkthrough that began in FIG. 13. In this figure Clusters K (962) and M (982) have been found as reasonable candidates for addition as clauses to the current query. They send logical signals 1900 and 1910 down to their constituent documents respectively. Documents that have already been examined are not re-examined, so documents #1 (921) and #2 (922) do not receive the signal. The system must then decide whether to test Cluster K (962) by presenting the user with Document #7 (927) or to test Cluster M (982) with Document #4 (924). In one preferred embodiment, documents that have been identified as not desirable results for the query are also taken into account, and in this case it would be noticed that document #7 (927) is closer in the hierarchy to document #3 (923) than document #4 (942) is to document #3 since the nearest shared ancestor of document #7 (927) and document #3 (923) is Tier-1 parent Cluster I (942), and the nearest shared ancestor of document #4 (933) and document #3 (933) is Tier-0 parent Cluster H (932). Since document #3 has been identified as not desirable output for the query, the system may then decide to test document #4 (924) and thus a clause the comprises Cluster M (982) is analyzed first. In this case the user is then presented with document #4 (924) and prompted as to whether it is a desirable result for the query or not. If so, a clause comprising Cluster M (982) will be added to the query (since all the child documents of this cluster will have already been tested as desirable by the user), the document ID for document #4 (924) would be added to the “Given” or “Like” clause of the query, and the search for new clauses might stop if the total recall (number of documents returned, or probability of a document being returned by the query) is sufficiently high, otherwise the search would continue for additional clauses, such as by testing Cluster J (992) for addition to the query. If Document #4 (924) is determined by the user to not be a desirable result for the query then a clause including Cluster M (982) will not be added to the query, document #4 (924) would be added to the “Unlike” clause of the query, and the process depicted in FIG. 11 would continue to search for clauses to add to the query.

It is also possible that refinements to the clustering within a single hierarchy are sought as clauses. For example, if Cluster M (982) was found to not be a good clause to add due to document #4 (924) having been found to not be a desirable result of the query, the search might continue searching whether cluster J (952) is a desirable clause, with the exception of excluding Cluster M (982). Thus, instead of only having clauses that include all the documents that are children of a certain cluster, it might include all the documents under a certain cluster that do not also fall under another particular cluster. For example, if cluster H 932 is a sub-cluster of a larger hierarchy, then we may find that Cluster H is a good candidate for addition to the list of clauses comprising the current query, but only if cluster M is excluded as a special case. Thus, such a clause that includes Cluster H (932) would not be required to include documents #1-#8 (921-928) but instead could be limited to accepting documents #1, #7, #3, #5, #8, and #6. Searching for such exclusions to a clause must be examined in the context of whether such a search is the best means of reaching the goals of the query with the current query, or whether an altogether different clause is more likely to benefit the query in a way that allows the query to achieve its goals more quickly. Thus, the main purpose of the interactive CQL query builder (420), which is to minimize the amount of time the user must spend in order to create queries that achieve their goals, is preferred and pursued by the system.

This process is very different from the process by which datasets have traditionally become labeled with supervised data. Such processes have traditionally not been optimized for user time in order to process unstructured data downstream with both traditional and nontraditional database systems.

A summary of the walkthrough depicted in FIGS. 13 through 19 might be that document examples send signals upward and clusters propagate these signals both upward and downward, so that the cluster is most promising at contributing a clause to the developing query is examined soonest. Both positive and negative examples can send signals, although these signals are aggregated and dispersed separately. The negative examples can be used, for example, to break ties that might otherwise occur using only positive examples. The upward and downward signal propagation within the hierarchy was discovered by the inventors from similar processes believed to occur in mammalian neocortical brain circuits, which are known to organize information hierarchically, and to propagate both bottom-up and top-down signals [Moorkanikara J, Chandrashekar A, Felch A, Furlong J, Dutt N, Nicolau A, Veidenbaum A, Granger R. (2007) Accelerating brain circuit simulations of object recognition with a Sony Playstation 3. International Workshop on Innovative Architectures (IWIA)]. These circuits further play a role in the looping circuit involving the basal ganglia, which is responsible for reinforcement-style learning [Aleksandrovsky, B., Brücher, F., Lynch, G., & Granger, R. (1997). Neural network model of striatal complex. In Biological and Artificial Computation: From Neuroscience to Technology (pp. 103-115). Springer Berlin Heidelberg.] similar in many respects to the way in which the interactive CQL query builder learns from the user's positive and negative responses.

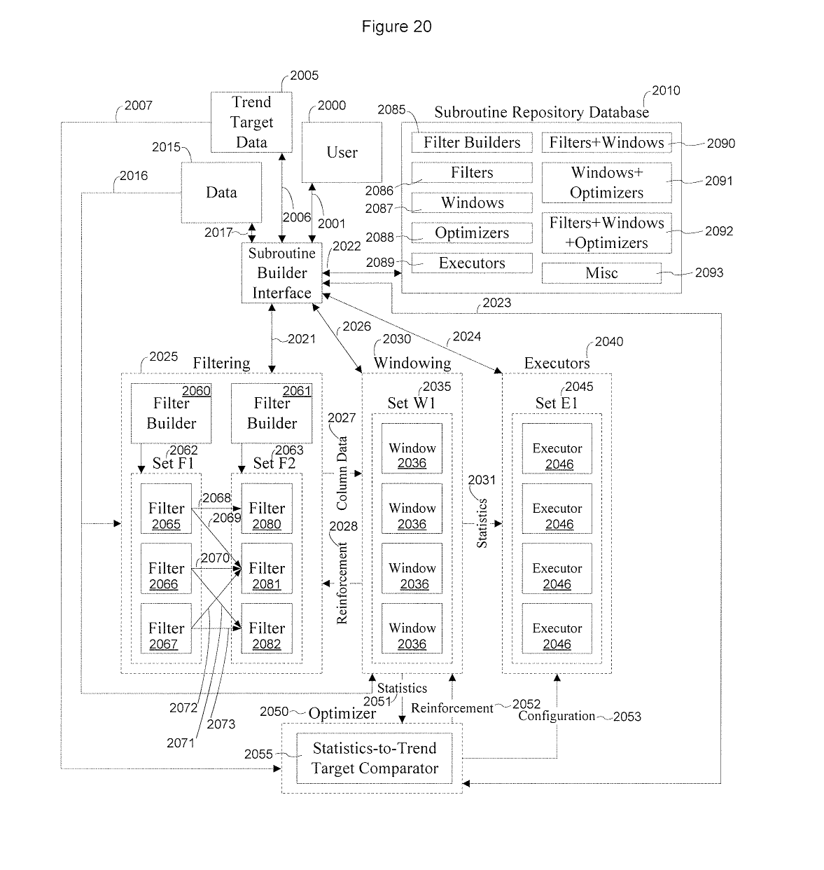

FIG. 20 depicts a preferred embodiment of the novel architecture wherein downstream Windowing (2030), Optimizer (2050), and Executor (2040) systems receive input from the upstream Filtering (2025) systems previously described. The algorithms that run within these systems are drawn from a Subroutine Repository Database (2010) and the selection of the algorithm is optimized for the user's task. The user is enabled to create new Subroutines by leveraging the Subroutine Builder Interface (2020) and existing subroutines (2085-2093), which can then become components of future subroutines created by the same user or other users in the case that they are marked as allowing such in the Subroutine Repository Database (2010). The User (2000) can be enabled through this system to perform actions in the Executors (2040) that act on predictions made about Trend Target Data (2005) that are worth acting upon. The Filtering (2025) system creates structured data that the Windowing (2030) system collects statistics on. The Optimizer (2050) correlates these statistics with the Trend Target Data (2005) and the Executors (2040) are configured by the Optimizer (2050), via link 2053, to act upon the predicted future of the Trend Target Data (2005).

The Subroutine Builder Interface implements the Interactive CQL Query Builder (420) interface and also implements further user interactions capable of configuring the Windowing (2030), Optimizer (2050) and Executors (2040). Furthermore, the Subroutine Builder Interface (2020) provides additional means of configuring the Filtering (2025) system beyond those described in FIG. 11. In fact, the hierarchy clusterers (1230, 1240) and CQL queries constructed through the process depicted in FIG. 11 are just a couple examples of subroutines supported by the Subroutine Repository Database (2010).

The User (2000) interacts with the Subroutine Builder Interface (2020) via link 2001 and selects a trend (2005) that he/she would like to predict in order to act upon those predictions. Thus, the User (2000) uses the Subroutine Builder Interface (2020) to select the Trend Target Data (2005) that will be used for the Subroutine that the user is building. The Subroutine Builder Interface (2020) then notifies the Trend Target Data (2005) via link 2006, which is either streaming in real time or held in storage, that it is to stream to the Optimizer (2050) via link 2007. The User (2000) also interfaces with the Subroutine Builder Interface (2020) via link 2001 in order to select what input data (2015) is to be utilized for the subroutine being created. The Subroutine Builder Interface (2020) then notifies the Input Data (2015) via link 2017 so that it is transmitted to the Filtering system (2025) via link 2016. The User (2000) then answers a series of prompts presented by the Subroutine Builder Interface (2020) and the Subroutine Builder Interface (2020) determines which subroutines (2085-2093) should be loaded from the Subroutine Repository Database (2010) into the Filtering (2025), Windowing (2030), Executors (2040), and Optimizer (2050) subroutine execution systems based on the goals, Trend Target Data (2005), Input Data (2015) selected by the User (2000), and the history of success associated with each of the subroutines (2085-2093) in the Subroutine Repository Database (2010).

The Subroutine Builder Interface (2020) selects one or more Filter Builders (2085) to load into the Filtering system (2025) via link 2021. The Filter Builders (2060, 2061) may then create the sets filters F1 and F2 (2062, 2063). There will be at least one set of Filters that does not require the output of other filters as input. In this example, Set F1 (2062) is the set of Filters (2065, 2066, 2067) that does not require the output of any other Filters. In the preferred embodiment depicted in FIG. 20, Set F2 (2063) comprises the set of Filters (2080, 2081, 2082) that do in fact require the output of other filters to be provided as input. More specifically, Filter 2080 requires the output of Filter 2065 to be provided as input via link 2068. Filter 2081 requires the output of filters 2065, 2066, and 2067 to be provided as input via links 2069, 2070, and 2072 respectively. Filter 2082 requires output from Filters 2066 and 2067 to be provided as input via link 2071 and 2073 respectively. Some filters may not be created by a Filter Builder (2060, 2061) but can be instead loaded from the set of Filters (2086) stored in the Subroutine Repository Database (2010). Loading can proceed via link 2022 to the Subroutine Builder Interface (2020) where it can be sent to the Filtering system (2025) via link 2021. A filter might be loaded instead of created if it is known that that filter is particularly good at predicting the designated Trend Target Data (2005) using the designated Data (2015), said designations being performed by the User (2000) through the Subroutine Builder Interface (2020) via link 2001.

The Filters (2065-2067 and 2080-2082) provide Column Data output (2027) to the Windowing system (2030) which includes a Set W1 of Windows (2035) comprising multiple Windows (2036) that collect statistics on the Column Data (2027) over time. The specific statistics collected by the Windowing system (2030) are determined by the Windows (2036) that are loaded by the Subroutine Builder Interface (2020) via link 2026. These Windows (2036) will have been selected from among the Windows (2087) available in the Subroutine Repository Database (2010) via link 2022 by prioritizing the loading of Windows (2087) that have previously proven useful at the User-designated Trend Target Data (2005) and Input Data (2015). The statistics collected by the Windows (2036) are output as Statistics (2031, 2051). The Optimizer (2050) receives the statistics input (2051) and processes it using its internal Statistics-to-Trend Target Comparator (2055), or STTC. In fact it is possible for the STTC (2055) to have multiple different possible instantiations housed in the Subroutine Repository Database (2010) and to be loaded by the Subroutine Builder Interface (2020) via link 2023. The STTC (2055) correlates the Trend Target Data (2005), provided via input 2007, with the Statistics input (2051) using the goals designated by the User (2000) which are communicated to the STTC (2055) by the Subroutine Builder Interface (2020) via link 2023.

Those statistics that are proving useful at predicting the Trend Target Data (2005) in accordance with the User's (2000) goals are identified through the processing of the STTC (2055). These identified statistics are transmitted back to the Windowing System (2030) via the Reinforcement link (2052). Subsequently, the Windowing system (2030) communicates back to the filtering system (2025) via the Reinforcement (2028) link. Those Filters on which useful statistics were collected according to the Reinforcement Signal will receive said Reinforcement (2028) from the Optimizer's (2050) STTC (2055).

The Filter Builders (2060, 2061) may then create more filters that are similar to the filters that have proven useful to the downstream systems. In order to make room for these filters, the Filter Builder (2060, 2061) may remove some unproven filters that have not proven useful after attempts to collect useful statistics over said unproven filters' outputs. The useful filters may then be transmitted from the Filtering system (2025), via link 2021, to the Subroutine Builder Interface (2020), via link 2021, and onward to the Subroutine Repository Database (2010), via link 2022. Once these useful filters have arrived at the Subroutine Repository Database (2010) they are stored in the repository so that they are available to the user for future subroutine building or for sale or trade to other users that may find them useful. Such third party users may desire to load these Filters (2086) if they are for sale in the case that said third party users are interested in predicting the same Trend Target Data (2005) using the same Input Data (2015), and that said Filters (2086) proved useful under those conditions. The Filtering system (2025) may have a direct link (not shown) to the Subroutine Repository Database (2010) in order to more efficiently retrieve and store Filters (2086) into the Subroutine Repository Database (2010). This extends to the Windowing (2030), Executor (2040), and Optimizer (2050) systems as well. If these direct links are present, the Subroutine Builder Interface (2020) does not need to transfer the data itself, but need only notify these systems (2025, 2030, 2040, 2050, 2010) of what data to send and who the receiver should be.

Upon successfully predicting the Trend Target Data (2005) under the goal conditions designated by the User (2000), the set of useful statistics and prediction configuration is sent from the Optimizer (2050) to the Executors system (2040) via the Configuration link (2053). The Executor comprises one or more sets (2045) of Executors (2046) that receive statistics as input (2031) from the Windowing system (2030) and, according to their configuration (2053), as performed by the Optimizer (2050), execute specific actions designated by the User (2000) in the case of successful prediction. Such actions might comprise sending coupons to users, changing a stock trading policy, retweeting a piece of news, modifying the proportion of purchases made from one supplier or another, or some other action.

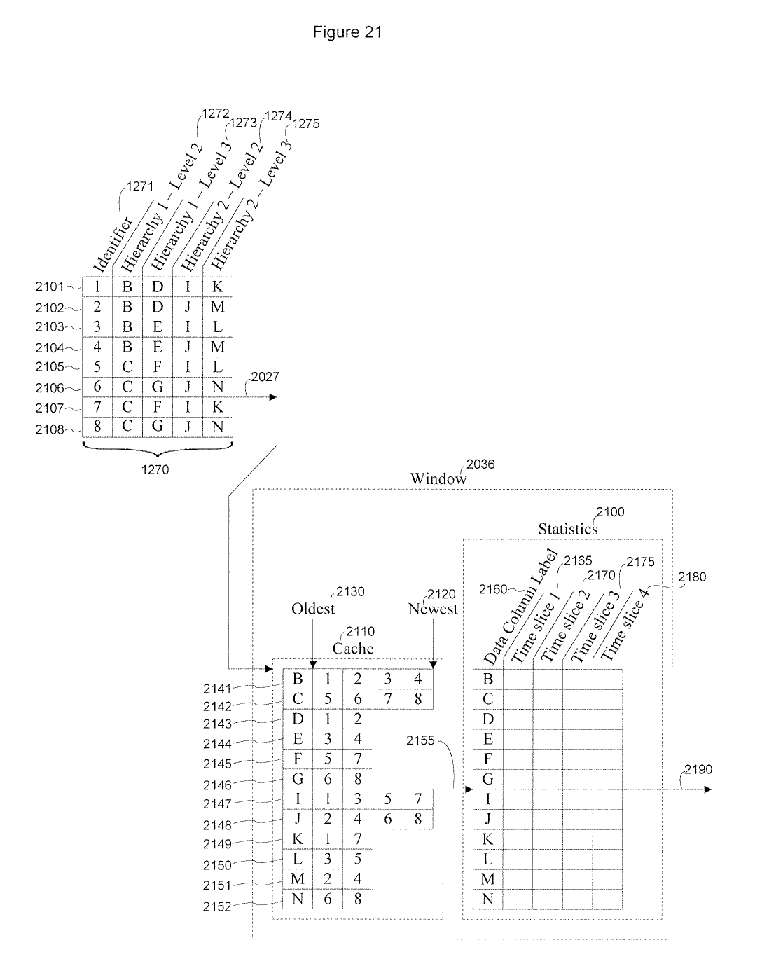

FIG. 21 depicts Column Data (1270) comprising Identifier (1271), Hierarchy 1—Level 2 cluster (1272), Hierarchy 1—Level 3 cluster (1273), Hierarchy 2—Level 2 cluster (1274), and Hierarchy 2—Level 3 cluster (1275). These are provided as input (2027) to the Window (2036) unit. The time of arrival (or a column value indicating the relevant timestamp) determines how the Cache (2110) stores the incoming data (2027). FIG. 21 demonstrates one possible implementation of a cache for explanatory purposes however an approximating method that does not store every data record individually in a cache (or individually for each relevant column of a given data record) could perform similar to the precise system depicted in FIG. 21. An approximating method would require less data storage capacity (e.g. memory capacity) in the caching system. Such an implementation might utilize counters. Such a method would perform well in the case that the chief statistic the cache is used to collect is the count of how many data records (1270) have been input with a given column data value (B, C, D . . . M, N) over various periods of time, up until the current moment. The method depicted in FIG. 21, which is one embodiment, shows the calculation of the counter statistics as separate from the caching storage. This would be a preferred embodiment, for example, if the time slices must be precise, or the time spans over which the time slices operate changes, or if the statistics are complex.

In this example Document #1 (2101) arrives first, followed by Document #2 (2102), and so on until Document #8 (2108) arrives last. At the beginning of the example the Cache (2110) is empty. More commonly there will already be data in the cache (2110) and the oldest data will be removed from the oldest pole (2130) of the cache (2110) to make room for new entries which will appear on the Newest Pole (2120). Because the cache (2110) starts out empty in our example we begin adding new entries to the cache (2110) at the oldest pole (2130) and move newer entries in a given row toward the newest pole (2120) as necessary until the row is filled. If the cache (2110) were to overflow in our example then entries would be removed from the oldest pole (2130) and added at the newest pole (2120). It is noteworthy that the poles are logical rather than a physical implementation, since sliding all of the data to the left whenever an entry is removed is an expensive operation. Ring buffers can implement the cache (2110) in the way described without requiring expensive memory operations.

When the first data (2101) arrives at the Cache (2110) via link 2027 it brings with it labels of B, D, I, and K in columns 1272, 1273, 1274, and 1275 respectively. The empty cache (2110) stores a new data record's Identifier column value (1271) in the relevant rows. In our example, for each hierarchical cluster that a data record belongs to, an entry is inserted into the corresponding row of the cache (2141-2152). This entry is stored as the data record's Identifier value (1271). Thus, a value of 1 is stored in the cache for Document #1 (2101). The value 1 is appended, starting from the left, to the B, D, I, and K rows (2141, 2143, 2147, 2149) because document #1 (2101) is in clusters B, D, I and K (941, 961, 942, 962). We can see in the cache (2110) that the value of 1 is nearest the oldest pole (2130) line in these rows (2141, 2143, 2147, 2149) showing that the value 1 was appended to the appropriate rows in the empty cache (2110).

When the second document (2102) arrives in the cache (2110), it's column values B, D, J, and M (for columns 1272, 1273, 1274, and 1275 respectively) result in the second document's (2102) ID value of 2 being stored in cache (2110) rows 2141, 2143, 2148, and 2150. Because document #1 came before it, it is positioned closer to the newest pole (2120) of the cache (2110) relative to document #1 (2101), in those rows (2141, 2143) where documents #1 and #2 (2101, 2102) both have entries. Thus, “2” goes to the right of the “1” value in rows 2141, and 2143. Upon arrival of document #3 (2103) as input, the column values of B, E, I, and L (for columns 1272, 1273, 1274, and 1275 respectively) are stored in the cache (2110) by appending “3” toward the right in rows 2141, 2144, 2147, and 2150 respectively. Upon arrival of document #4 (2104) as input, the column values of B, E, J, and M (for columns 1272, 1273, 1274, and 1275 respectively) are stored in the cache (2110) by appending “4” toward the right in rows 2141, 2144, 2148, and 2151 respectively. Upon arrival of document #5 (2105) as input, the column values of C, F, I, and L (for columns 1272, 1273, 1274, and 1275 respectively) are stored in the cache (2110) by appending “5” toward the right in rows 2142, 2145, 2147, and 2150 respectively. Upon arrival of document #6 (2106) as input, the column values of C, G, J, and N (for columns 1272, 1273, 1274, and 1275 respectively) are stored in the cache (2110) by appending “6” toward the right in rows 2142, 2146, 2148, and 2152 respectively. Upon arrival of document #7 (2107) as input, the column values of C, F, I, and K (for columns 1272, 1273, 1274, and 1275 respectively) are stored in the cache (2110) by appending “7” toward the right in rows 2142, 2145, 2147, and 2149 respectively. Upon arrival of document #8 (2108) as input, the column values of C, G, J, and N (for columns 1272, 1273, 1274, and 1275 respectively) are stored in the cache (2110) by appending “8” toward the right in rows 2142, 2146, 2148, and 2152 respectively. Since Document #8 (2108) is the last to arrive we can see that in each of the rows in which it was appended it is the rightmost entry for that row.

Statistics (2100) are gathered on these cache rows (2141-2152), which are sorted through time, and running tallies are kept for each of the different time slice time spans (2065, 2070, 2075, 2080) that will be calculated for statistics (2100). In one preferred embodiment, time slice 1 (2165) is 1 minute, time slice 2 (2170) is 5 minutes, time slice 3 (2175) is 1 hour, and time slice 4 (2180) is 24 hours. In another preferred embodiment the statistics are the sum of the number of data records (documents) that have had a column value equal to the Data Column Label 2160 during a particular time slice (2165-2180). In such an example the time slice 4 column (2180) would always hold values at least as large as the adjacent time slice 3 (2175) values, time slice 3 (2175) would always hold values at least as large as the adjacent time slice 2 (2170) values, and time slice 2 (2165) would always hold values at least as large as the adjacent time slice 1 (2165) values. In another preferred embodiment, the difference in this sum from some parameter is calculated and output. In another embodiment the percentage of all data records that have a specific Data Column Label as a column value is measured. This technique would be valuable if the number of data records that arrive via link 2027 is affected by noise, since a percentage formula naturally adjusts to periods when less data arrives. The statistics (2100) are output whenever a change is made in one of the values it holds, and the change is output over link 2190. In another embodiment the full statistics data structure is output at a certain period, such as every 10 milliseconds, or ever minute. In another embodiment both techniques are used, where the periodic output serves as a keyframe to downstream systems that are monitoring data provided over link 2190. Updates between periodic keyframe updates would then only be required to send information regarding which data has changed, and what value it has changed to. Alternatively, the value it has changed to can be relative to the keyframe value or its previous value, so long as the difference and the sign of the difference are sent, and this may require fewer bits-per-changed-value to be transmitted. This might enable improved performance in cases where bandwidth limitations are limiting performance.

A given CQL query may be implemented as a filter, where data records will be given a new column related to the name of the CQL query. Let's consider a CQL query named Q1. A given data record will have a value of “True” for column Q1 if the data record would be returned as a result by Q1, otherwise it may get a “False” value. An example Q1 could be:
SELECT*FROM TABLE_1270 WHERE Hierarchy_{—}1_Level_{—}2=‘B’ AND Hierarchy_{—}2_Level_{—}3=‘M’;

(here TABLE_1270 is a reference to the table 1270 of FIG. 12.) If this CQL query is run on the development input data (e.g. 410) then it would return documents #2 and #4 (2102, 2104). If run on an incoming stream it would return results whenever Hierarchy 1 assigns a Level 2 cluster of B and Hierarchy 2 assigns a Level 3 cluster of M. If this query is run as a filter then it will simply add Q1 column information and documents like document #2 and #4 (2102, 2104) will receive values of “true” in this column, while other data will receive “no” (or the “Not Applicable” value can be repurposed as the false value, so that the advantages of sparse representations of the true values can be automatically taken advantage of).

In another preferred embodiment, the table name is used to designate which hierarchy is being analyzed. Such a query might look like:
SELECT*FROM HIERARCHY_{—}1 WHERE LEVEL+3=‘G’;

One can further imagine that third parties implement filters that assign a mood to a given piece of text. A CQL query operating on this data might well appear as:
SELECT*FROM TABLE_1270 WHERE MOOD=‘HAPPY’;

Another means of leveraging the capabilities of the CQL queries appears when the window (2036) units are integrated. One method returns all of the data records when a particular statistic value is reached. For example:
SELECT*FROM TABLE_1270 WHERE G_Time_slice_{—}2>5;

This might select all of the records that cause the Time slice 2 statistic (2070) to exceed the value of 5. These data records could then possibly be processed further by downstream systems. Another method could be used to simply extract the event, rather than the data. For example:
SELECT G_Time_slice_{—}2 FROM TABLE_1270 WHERE G_Time_slice_{—}2>5;

These queries can be run indefinitely on incoming streams and the results of these queries, which may achieve insight into the unstructured portion of data records by using hierarchy filters or other filters within their clauses, can be inserted into traditional SQL databases. Thus CQL queries (and the subroutines that support them) may act as an adapter from unstructured data to structured data.

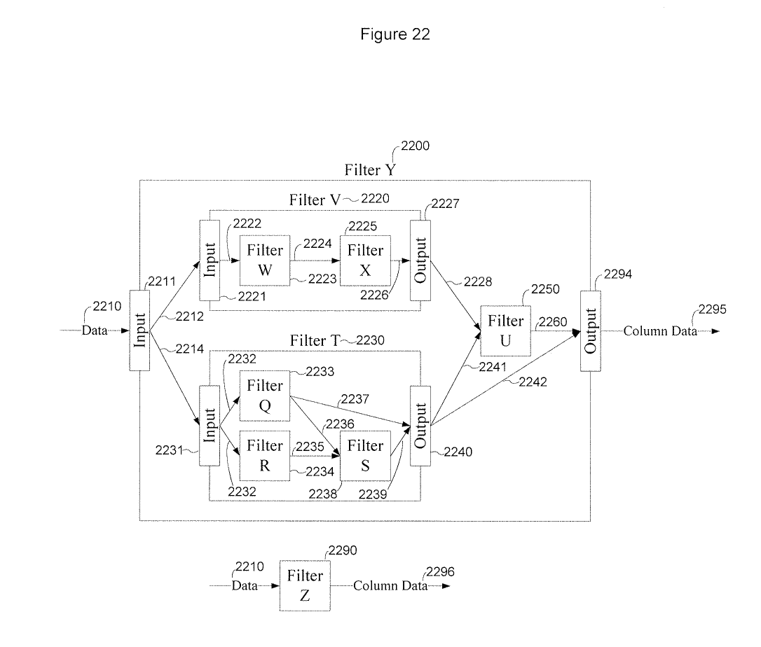

FIG. 22 depicts a case of nested filters in which Filter Y (2200) is comprised of Filter V (2220), Filter T (2230), and Filter U (2250). Filter V (2220) itself is comprised of Filter W (2224) and Filter X (2225). Filter T (2230) is itself comprised of Filters Q, R, and S (2233, 2234, 2238). Beyond containing filters within them, filters organize their constituents' inputs and outputs in specific ways. This is done by linking one filter's output to another filter's input. Such is the case with link 2224. Although not shown, the input to the parent filter is also available to all internal filters. In this way it is possible for a User (2000) to build their own filter, which is one kind of subroutine, by plugging multiple filters (subroutines) into each other. The sale of the subroutine made by the User (2000) can take into account the fees that are charged by the component filters (subroutines). If the conditions of sale and/or rent of the subroutines are pay-per-use then it can be very inexpensive for users to create subroutines and put them for sale, since the subroutines that are made use of by a User's subroutine can be paid on demand and do not need to be stocked and purchased before hand. The subroutine repository database (2010) can carry out the charging of accounts according to the sale and fee structure of subroutines as they are used.

Filter Z (2290) is an example of a stand-alone filter, although it could be used as a component of a larger subroutine. Filter Z (2290) receives Data input (2210) and produces Column Data output (2296). Filter Y (2200) receives Data (2210) at its Input (2211) and propagates this input to the filters that use it, namely Filter V (2220) and Filter T (2230) via links 2212 and 2214 respectively. Filter V receives the Input (2221) and feeds it to Filter W (2223) via link 2222. Filter W in turn outputs Column Data via link 2224 which is provided as input to Filter X (2225). Filter X (2225) may make use of the original input (2221) as well as the Column data received via link 2224 in order to produces its own output which is sent via link 2226. This column data (2226) is sent to the output (2227) of Filter V (2220). Filter W (2223) may optionally send its output to the output (2227) of Filter V (2220), however in the example of FIG. 22 this is not the case as there is no link for the output of Filter W (2223) to the Output (2227) of Filter V (2220).

Filter T (2230) receives input (2231) and sends this to Filters Q and R (2233, 2234) via links 2232. Filter Q (2233) and Filter R (2234) receive link 2232 as input. Filter Q (2233) produces column data and outputs this via links 2236 and 2237 which are sent to Filter S (2238) and to the output (2240) of Filter T (2230) respectively. Filter R (2234) produces column data which is output via link 2235. Filter S (2238) receives input from the output of both Filter Q (2233) and Filter R (2234) via links 2236 and 2235 respectively. Filter S (2238) may also make use of the Input (2231) provided to its parent filter T (2230). Filter S (2238) then processes its input and produces column data output which is transferred via link 2239 to the output (2240) of Filter T (2230). The outputs (2227, 2240) from Filters V and T (2220, 2230) are sent to be processed by Filter U (2250) as input, via links 2228 and 2241 respectively. Filter U (2250) processes its inputs (2228, 2241), and may process the input (2211) to its parent Filter Y (2200) as well. Filter U (2250) then produces output (2260) which, along with the output (2240) from Filter T (2230) that is sent via link 2242, are received by Filter Y's (2200) output (2294). This column data is then sent from the output (2294) as Column Data output (2295). Thus Filter Y (2200) is a subroutine comprised of subroutines (2220, 2230, 2250), which may themselves comprise subroutines; and whenever a subroutine is comprised of other subroutines it organizes their inputs and outputs in a certain way to carry out the computation of the parent filter.

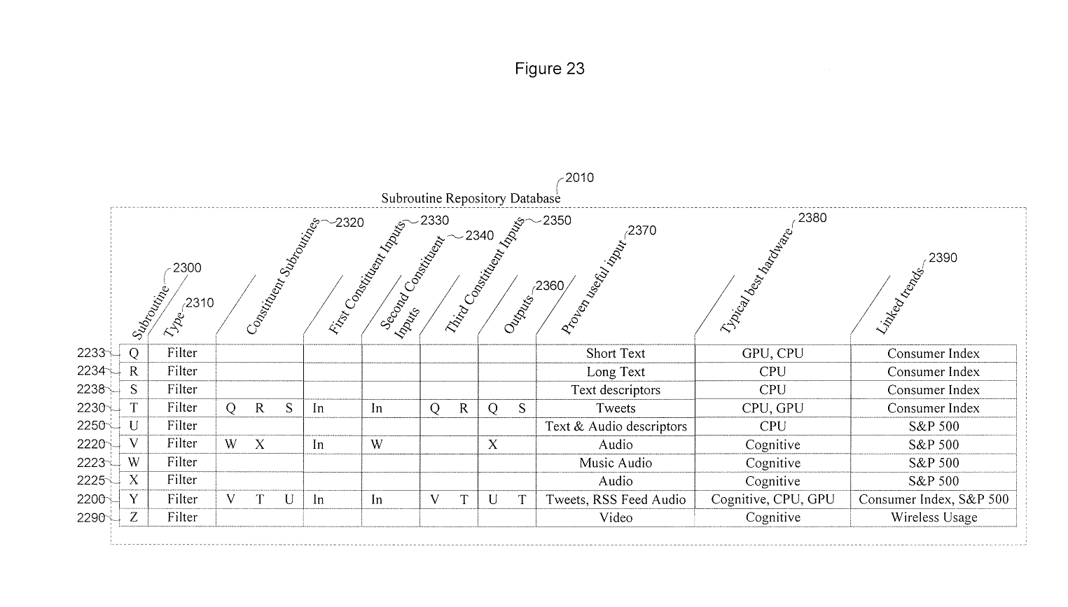

FIG. 23 depicts a preferred embodiment of the Subroutine Repository Database (2010) that includes row entries (2233, 2234, 2238, 2230, 2250, 2220, 2223, 2225, 2200, 2290) for Filters Q, R, S, T, U, V, W, X, Y, and Z (respectively). The Subroutine Repository Database (2010) holds column values, when applicable, for each row entry, and each row entry represents a subroutine. Subroutine Q (2233) has an entry of “Q” for the Subroutine name (2300), and a value of “Filter”, as do all entries in the example table of FIG. 23, for the “Type” column (2310) indicating that the subroutine is a filter. Because all entries in the example table of FIG. 23 are of type “Filter”, the terms subroutine and filter will be used synonymously in the description of FIG. 23 (e.g. subroutine Q and Filter Q describe the same thing). The “Type” field (2310) identifies what functions the subroutine can perform inside a larger subroutine that uses it as a component. In programming languages an analog to this column is sometimes called an interface. The “Proven useful input” column (2370) lists example input(s) that have been successfully processed by the given subroutine in prior instantiations. In the example of FIG. 23 the Q subroutine (2233) has proven useful on “Short Text” input data. Text messages and tweets might be considered examples of “Short Text”. The “Typical best hardware” column (2380) indicates what hardware has proven best at running this particular subroutine. In the case of Subroutine Q (2233), the GPU (graphics processor unit) and CPU (Central Processing Unit) hardware architectures have performed it efficiently. The “Linked Trends” column (2390) indicates what trends have been successfully predicted by the subroutine. In the case of the Q subroutine (2233), the Consumer Index (i.e. Consumer Price Index) has been successfully predicted. In another preferred embodiment the exact parings of input (2370) and Linked Trends (2390) that have been successful for a given subroutine are stored as a list of pairs, so that an exact match of this pairing to a new user's use case is taken as more indicative than a match of the useful input column (2370) and linked trends column (2390) individually. If no exact pairing match is available then such a system might fall back on prioritizing selection of a Filter that has done each individually, and if no such subroutine exists, then a subroutine that has processed the given input successfully might be preferred, and if no such subroutine exists then a subroutine that has successfully predicted a given trend might preferred. In this way the historical successes of a given subroutine are analyzed carefully in relation to the current User's (2000) goals so that subroutines that are truly likely to be successful at achieving the User's (2000) goals are recruited as candidates first.

The example subroutines (2200, 2220, 2223, 2225, 2230, 2233, 2234, 2238, 2250, 2290) of FIG. 22 are stored in FIG. 23's Subroutine Repository Database (2010) such that subroutine R (2234) has “Proven useful input” column (2370) value of “Long Text”, a “Typical best hardware” column (2380) value of “CPU”, and a “Linked trends” column (2390) value of “Consumer Index”; whereas all other columns for subroutine R (2234) are not applicable. Subroutine S (2238) has a “Proven useful input” column (2370) value of “Text descriptors”, a “Typical best hardware” column (2380) value of “CPU”, and a “Linked trends” column (2390) value of “Consumer Index”; whereas all other columns for subroutine S (2238) are not applicable.

The entry for Subroutine T (2230) makes use of other entries in the Subroutine Repository Database (2010), namely subroutines Q, R, and S (2233, 2234, 2238), by referencing these subroutines as Constituent Subroutines (2320). We can see that Filter T (2230) contains Filters Q, R, and S (2233, 2234, 2238) in FIG. 22, and the Subroutine Repository Database (2010) has noted this in parent subroutine T's (2230) Constituent Subroutines (2320) value. Note that because Q (2233) is listed first in the value, the values in the First Constituent Inputs (2330) column for the parent subroutine T (2230) pertain to subroutine Q (2233). Similarly, because R (2233) is listed second in the value, the values in the Second Constituent Inputs (2340) column for the parent subroutine T (2230) pertain to subroutine R (2234). Finally, because subroutine S (2238) is listed third in the value, the values in the Third Constituent Inputs (2350) column for the parent subroutine T (2230) pertain to subroutine R (2234).

The row entry for subroutine T (2230) has a “First Constituent Inputs” (2330) value of “In”, which denotes that the First Constituent Subroutine Q (2233) receives a link from the Input to subroutine T (2230). This is represented in FIG. 22 as the link (2232) connecting Filter Q (2233) with the Input (2231) of subroutine T (2230). The row entry for subroutine T (2230) has a “Second Constituent Inputs” (2340) value of “In” which denotes that the Second Constituent Subroutine R (2234) receives a link from the Input (2231) to subroutine T (2230). This is represented in FIG. 22 as the link (2232) connecting Filter R (2234) with the Input (2231) of subroutine T (2230). The row entry for subroutine T (2230) has “Third Constituent Inputs” (2350) values of Q and R (2233, 2234) which denotes that the Third Constituent Subroutine S (2238) receives an input link from the Output (2236) of Subroutine Q (2233) and the Output (2235) of Subroutine R (2234). This is represented in FIG. 22 by the link (2236) connecting the output of Filter Q (2233) to Filter S (2238), and by the link (2235) connecting the output of Filter R (2234) to Filter S (2238). Finally, the Outputs column (2360) for row entry T (2230) has a values of Q and S (2237, 2239) indicating that subroutine Q (2233) and subroutine S (2238) send outputs to the output (2240) of subroutine T (2230). This is shown in FIG. 22 by the link (2237) connecting the output of Filter Q (2233) to the output (2240) of Filter T (2230), and by the link (2239) connecting the output of Filter S (2238) to the output (2240) of Filter T (2230).

Additional columns for Fourth Constituent etc. may also be included in a preferred embodiment. The columns that are not applicable to a particular entry may not require storage overhead for the “not applicable” symbol if they are stored in a sparse format. Such a format stores the column name, or another identifier of the column, with the value held in that column. A secondary means of not storing values for column-row pairs that would not hold “not applicable” values is to use a reverse index wherein each value that occurs in a column is made to point to the list of rows that contain that value.

Subroutine T (2238) further comprises a “Tweets” value for the “Proven useful input” column (2370), CPU and GPU values for the “Typical best hardware” column (2380), and a “Consumer Index” value for the “Linked trends” column (2390).

Subroutine U 2250 has “Proven useful input” column (2370) value of “Text and audio descriptors”, a “Typical best hardware” column (2380) value of “CPU”, and a “Linked trends” column (2390) value of “S&P 500”, whereas all other columns for subroutine U (2250), besides the subroutine column 2300 and Type column 2310, are not applicable.

The entry for Subroutine V (2220) makes use of other entries in the Subroutine Repository Database (2010), namely subroutines W and X (2223, 2225) by referencing these subroutines as Constituent Subroutines (2320). We can see that Filter V (2220) contains Filters W and X (2223, 2225) in FIG. 22, and the Subroutine Repository Database (2010) has noted this in parent subroutine V's (2220) Constituent Subroutines (2320) value. Note that because W (2223) is listed first in the value, the values in the First Constituent Inputs column (2330) for the parent subroutine V (2220) pertain to subroutine W (2223). Similarly, because X (2235) is listed second in the value, the values in the Second Constituent Inputs (2340) column for the parent subroutine V (2220) pertain to subroutine X (2235).

The row entry for subroutine V (2220) has a “First Constituent Inputs” (2330) value of “In” which denotes that the First Constituent Subroutine W (2223) receives a link from the Input to subroutine V (2220). This is represented in FIG. 22 as the link (2222) connecting Filter W (2223) with the input (2221) of subroutine V (2220). The row entry for subroutine V (2220) has a “Second Constituent Inputs” (2340) value of W (2223), which denotes that the Second Constituent Subroutine X (2225) receives an input link from the output of subroutine W (2223). This is represented in FIG. 22 as the link (2224) connecting the output of Filter W (2223) to Filter X (2225). Finally, the Outputs column (2360) for row entry V (2220) has a values of X (2225), indicating that subroutine X (2225) sends output to the output of subroutine V (2220). This is shown in FIG. 22 as the link (2226) connecting the output of Filter X (2225) to the output (2227) of Filter V (2220).

Subroutine V (2220) further comprises an “Audio” value for the “Proven useful input” column (2370). Subroutine V (2220) also has a “Cognitive” value for the “Typical best hardware” column (2380), which indicates that the computer hardware based on the Cognitive architecture developed by Cognitive Electronics may best execute Filter V (2220). Subroutine V (2220) further has an “S&P 500” value for the “Linked trends” column (2390), which indicates that the value of the S&P 500 stock has been successfully predicted using Filter V (2220).

Subroutine W (2223) has “Proven useful input” column (2370) value of “Music Audio”, a “Typical best hardware” column (2380) value of “Cognitive”, and a “Linked trends” column (2390) value of “S&P 500”; whereas all other columns for subroutine W (2223), besides the Subroutine column (2300) and Type column (2310), are not applicable. Subroutine X 2225 has a “Proven useful input” column (2370) value of “Audio”, a “Typical best hardware” column (2380) value of “Cognitive”, and a “Linked trends” column (2390) value of “S&P 500”; whereas all other columns for subroutine X (2225), besides the Subroutine column (2300) and Type column (2310), are not applicable.

The entry for Subroutine Y (2200) makes use of other entries in the Subroutine Repository Database (2010), namely subroutines V, T, and U (2220, 2230, 2250), by referencing these subroutines as Constituent Subroutines (2320). We can see that Filter Y (2200) contains Filters V, T, and U (2220, 2230, 2250) in FIG. 22, and the Subroutine Repository Database (2010) has noted this in parent subroutine Y's (2200) Constituent Subroutines (2320) value. Note that because V (2220) is listed first in the value, the values in the First Constituent Inputs column (2330) for the parent subroutine Y (2200) pertain to subroutine V (2220). Similarly, because T (2230) is listed second in the value, the values in the Second Constituent Inputs (2340) column for the parent subroutine Y (2200) pertain to subroutine T (2230). Finally, because U (2250) is listed third in the value, the values in the Third Constituent Inputs column (2350) for the parent subroutine Y (2200) pertain to subroutine U (2250).

The row entry for subroutine Y (2200) has a “First Constituent Inputs” (2330) value of “In”, which denotes that the First Constituent Subroutine V (2220) receives a link from the Input to subroutine Y (2230). This is represented in FIG. 22 as the link (2212) connecting the input (2221) of Filter V (2220) with the input (2211) of subroutine Y (2200). The row entry for subroutine Y (2200) has a “Second Constituent Inputs” (2340) value of “In”, which denotes that the Second Constituent Subroutine T (2230) receives a link from the input (2211) of subroutine Y (2200). This is represented in FIG. 22 as the link (2214) connecting the input (2231) of Filter T (2231) with the input (2211) of Filter Y (2200). The row entry for subroutine Y (2200) has “Third Constituent Inputs” (2350) values of V and T (2220, 2230), which denotes that the Third Constituent Subroutine U (2250) receives an input link from the output of subroutine V (2220) and the output of subroutine T (2230). This is represented in FIG. 22 as the link (2228) connecting the output (2227) of Filter V (2220) to Filter U (2250), and the link (2241) connecting the output (2240) of Filter T (2230) to Filter U (2250). Finally, the Outputs column (2360) for row entry Y (2200) has values of U and T indicating that subroutine U (2250) and subroutine T (2230) send output to the output of subroutine Y (2294). This is shown in FIG. 22 as the link (2260) connecting the output of Filter U (2250) to the Output (2294) of Filter Y (2200), and the link (2242) connecting the output (2240) of Filter T (2230) to the output (2294) of Filter Y (2200).

Subroutine Y (2200) further comprises “Tweets” and “RSS Feed Audio” values for the “Proven useful input” column (2370), “Cognitive”, CPU and GPU values for the “Typical best hardware” column (2380), and “Consumer Index” and “S&P 500” values for the “Linked trends” column (2390).

Subroutine Z (2290) has a “Proven useful input” column (2370) value of “Video”, a “Typical best hardware” column (2380) value of “Cognitive”, and a “Linked trends” column (2390) value of “Wireless usage”; which indicates that subroutine Z (2290) has previously been used successfully to predict the wireless usage (e.g. bandwidth consumed) in a particular environment. All other columns for subroutine Z (2290), besides the Subroutine column (2300) and Type column (2310) are not applicable.

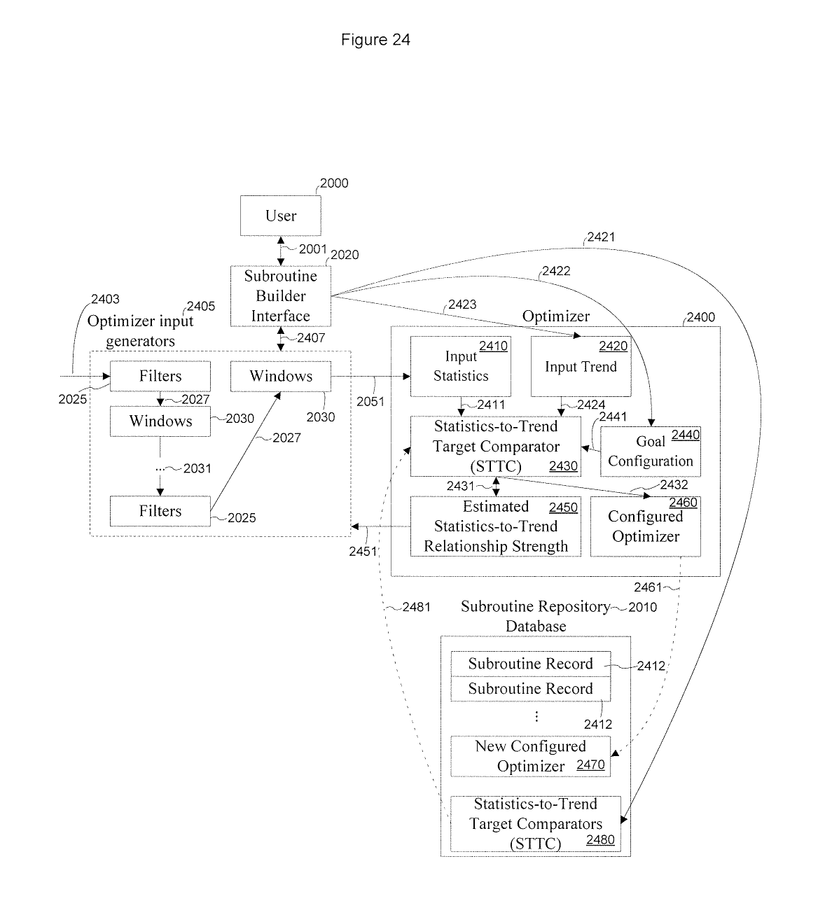

FIG. 24 depicts the novel system with the internals of the optimizer (2400) displayed, along with its interactions with its input (2405), the User (2000), the Subroutine Builder Interface (2020), and the Subroutine Repository Database (2010).

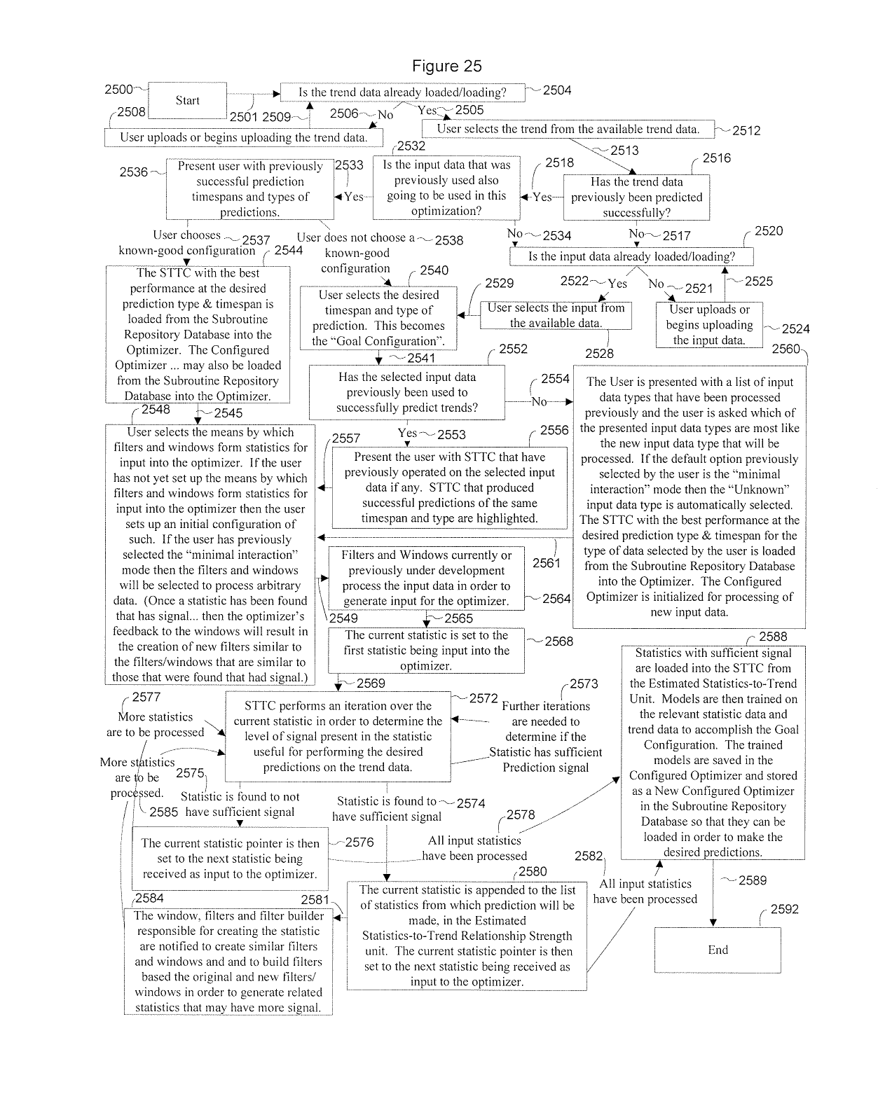

The User (2000) interacts with the Subroutine Builder Interface (2020) via link 2001 in order to designate the input (2403), preferred organization of the Filters and Windows (2025, 2030), if any, and other configurable parts of the novel system. The user may select, through the Subroutine Builder Interface (2020), which STTC (2480) should be used from the Subroutine Repository Database (2010). The Subroutine Repository Database (2010) houses multiple Subroutine Records (2412), which was previously described in FIG. 23. The Subroutine Builder Interface (2020) then loads the selected STTC (2480) by notifying the Subroutine Repository Database (2010) of the selection via link 2421. The Subroutine Repository Database (2010) then sends the selected STTC (2480) to the Optimizer's loaded STTC (2430) via link 2481. If the User (2000) does not select a preferred STTC (2480), then the Subroutine Builder Interface (2020) selects the STTC (2480) it anticipates is most likely to succeed. The means by which this and other selections, are made is depicted in FIG. 25, which will be described subsequently.

The User (2000) further configures the subroutine under construction with the selected Input Trend (2420), which is communicated to the Optimizer (2400) via link 2423. The User (2000) further configures the subroutine under construction with the Goal Configuration (2440) via link 2422, which describes the type of prediction that is to be made on the Input Trend (2420). Correlation between the Input Statistics (2410) and the Input Trend (2420) are calculated in the STTC (2430) that has been loaded into the Optimizer (2400). The Input Statistics (2410) and the Input Trend (2420) are communicated to the loaded STTC (2430) via links 2411 and 2424 respectively. Correlation is calculated by the STTC (2430) with the specific goal (2440) that has been specified by the User (2000), which may, for example, dictate how far into the future the Input Trend (2420) is to be predicted, the granularity at which the prediction is to be made, and how confidence in the prediction may be communicated. The goal configuration (2440) is communicated to the STTC (2430) via link 2441. The method used by the loaded STTC (2430) is specific to the STTC (2480) that was selected from the Subroutine Repository Database (2010) by the Subroutine Builder Interface (2020).

Estimated Statistics-to-Trend Relationship Strength (2450) is output by the loaded STTC (2430) via link 2431. The best statistics-to-trend correlations that have been stored in the Estimated Statistics-to-Trend Relationship Strength unit (2450) are reloaded into the STTC (2430) via link (2431) at which point the STTC (2430) creates a predictor of the Input Trend (2420) from specific Input Statistics (2410) according to the selected goals (2440). This predictor is called the Configured Optimizer (2460), and is output via link 2432. The Configured Optimizer (2460) is then loaded into the Subroutine Repository Database (2010) via link 2461, where it is stored as a New Configured Optimizer (2470). The New Configured Optimizer (2470) may then be loaded into an Executor (2046) that, with additional configuration by the User (2000), performs actions based on the predictions of the New Configured Optimizer (2470).

FIG. 25 depicts the processes that enable the Optimizer (2400) and Subroutine Builder Interface (2020) to build subroutines that are likely to succeed according to a User's (2000) goals.

Step 2500 is the “Start” step. This step begins the process depicted in FIG. 25. This step proceeds immediately to step 2504 via link 2501.

Step 2504 is the “Is the trend data already loaded/loading?” step. In this step the flow of the process depicted in FIG. 25 diverges based on whether the trend data is already loaded and/or loading or has not yet been loaded or started loading. The process proceeds to step 2512 via “Yes” link 2505 in the case that the trend data is already loaded or loading, or to step 2508 via “No” link 2506 in the case that the trend data is not yet loaded or loading.

Step 2508 is the “User uploads or begins uploading the trend data” step. In this step the user uploads historical trend data or begins uploading a continuous stream of trend data from which historical trend data will be gathered. From this step the process proceeds to step 2504 via link 2508.

Step 2512 is the “User selects the trend from the available trend data” step. In this step the user will be presented with a means of navigating their selection through the available trend data toward the trend data they would like the system to use. In a preferred embodiment the User (2000) began uploading a proprietary stream of real-time purchases in step 2508 and the User (2000) selects this trend data stream during this step. In another preferred embodiment the User (2000) is presented with some available trend data that has a fee associated with it, such as historical stock price data. In this embodiment the system may present the user with an indicator signaling that this trend data has a fee associated with it, and this signal may include the specific price associated with the data. In another preferred embodiment the user is presented with real-time streaming stock price trend data and the fee for this data may be amortized over all users or grouped with other trends and made available through a bundle with a discount relative to purchasing the trend data individually. From this step the process proceeds to step 2516 via link 2513.

Step 2516 is the “Has the trend data previously been predicted successfully?” step. In this step the historical successes of the trend data is consulted so as to help the User (2000) make successful predictions on the trend data. Historically successful predictions on this trend data may be stored in the Subroutine Repository Database (2010) or in another storage medium. For trend data that has been successfully predicted many times and/or in many different ways, the relevant data from the Subroutine Repository Database (2010) may be condensed into summarized data so that all of the successful records do not need to be consulted whenever a User (2000) would like to make a new prediction of this trend data. Such a summarizing data structure may be updated whenever a new user or new type of prediction is successful at predicting the trend data. This step proceeds either to step 2520 via “No” link 2517 (in the case that the trend data has not previously been predicted successfully), or to step 2532 via “Yes” link 2518 (in the case that the trend data has in fact previously been predicted successfully).

Step (2520) is the “Is the input data already loaded/loading?” step. This step serves the purpose of allowing the process to diverge in its path based on whether the input data is already loaded or loading, or whether it has not. The process proceeds from this step to step 2524 via “No” link 2521 (in the case that the input data is not currently loaded or loading), or to step 2528 via “Yes” link 2522 (in the case that the input data is already loaded or loading).

Step 2524 is the “User uploads or begins uploading the input data” step. The process proceeds from this step to step 2520 via link 2525.

Step 2528 is the “User selects the input from the available data” step. In this step the user is presented with options for input data, which will be used to make predictions on the trend data. In one preferred embodiment the User (2000) may select twitter data with particular tags as the input data. In another preferred embodiment the user may select the twitter firehose (unfiltered twitter data) should such data be available. In another preferred embodiment, the user may be presented with multiple free input data options, such as RSS feed updates or Wikipedia website updates, and multiple pay-for options, such as proprietary real-time social network user data. The process proceeds from step 2528 to step 2540 via link 2529.

Step 2532 is the “Is the input data that was previously used also going to be used in this optimization?” step. This step serves as a divergent step for the process depicted in FIG. 25. In this step the User (2000) may be presented with the set of previously used input data that was utilized to successfully predict the trend data. The User (2000) may choose one of these options by simply selecting one of the options that is listed that can be used to achieve the user's prediction goals (and in a later step the user can select the specific input data that is to be used). In another preferred embodiment the User's (2000) choice may be inferred from a user-selected option that enables the process depicted in FIG. 25 to use whatever input data the system estimates to be the most likely input data to achieve the User's (2000) goals (in this case the “Yes” link would be followed). This step proceeds to step 2536 via “Yes” link 2533, or to step 2520 via “No” link 2534.

Step 2536 is the “Present user with previously successful prediction timespans and types of predictions” step. In this step the historical data related to the set of successful predictions that have been made using the selected trend data is processed by the system. The system may retrieve this data from the Subroutine Repository Database (2010) or from another medium on which these historically-successful predictions have been stored. The User (2000) is guided through the set of previously successful timespans and types of predictions so that the user may choose from amongst these prediction timespans and types of predictions. In the case that the user selects one of these previously successful prediction types and timespans, the prediction is considered more likely to succeed. This is because a use case very similar to the current User's (2000) use case was previously successful. Such a selection is considered “known-good”. The process proceeds from this step 2536 to step 2544 via the “User chooses known-good configuration” link (2537), or to step 2540 via the “User does not choose a known-good configuration” link (2538).

Step 2540 is the “User selects the desired timespan and type of prediction. This becomes the Goal Configuration” step. In this step the User (2000) chooses a timespan and type of prediction from the list of possible timespans and types of predictions, rather than from the list of known-good timespans and types of predictions. One way in which this differs from step 2536 is that the timespan and type of prediction may be chosen independently of each other, whereas in the selection from known-good prediction types and timespans the user was presented with paired options when a particular timespan was not known-good for all prediction types, or vice versa. The process proceeds from this step to step 2552 via link 2541.

Step 2544 is the “The STTC with the best performance at the desired prediction type & timespan is loaded from the Subroutine Repository Database into the Optimizer. The Configured Optimizer that resulted from the selected STTC instance may also be loaded from the Subroutine Repository Database into the Optimizer” step. In this step the system is configured to perform similar to the previously known-good configuration that was selected. The process proceeds from this step to step 2548 via link 2545.

Step 2548 is the “User selects the means by which filters and windows form statistics for input into the optimizer. If the user has not yet set up the means by which filters and windows form statistics for input into the optimizer then the user sets up an initial configuration of such. If the user has previously selected the “minimal interaction” mode then filters and windows will be automatically selected to process arbitrary data. (Once a statistic has been found that has signal relative to predicting the desired trend, then the optimizer's feedback to the windows will result in the creation of new filters similar to those that were found to have signal.)” step. The process proceeds from this step to step 2564 via link 2549.

Step 2552 is the “Has the selected input data previously been used to successfully predict trends?” step. The process proceeds from this step to step 2560 via “No” link 2554, or to step 2556 via “Yes” link 2553.

Step 2556 is the “Present the user with STTC that have previously operated on the selected input data if any. STTC that produced successful predictions of the same timespan and type are highlighted” step. The data presented to the user may be retrieved from the Subroutine Repository Database 2010 or from some other database storing the relevant information. The process proceeds from this step to step 2548 via link 2557.

Step 2560 is the “The User is presented with a list of input data types that have been processed previously and the user is asked which of the presented input data types are most like the new input data type that will be processed. If the default option previously selected by the user is the “minimal interaction” mode then the “Unknown” input data type is automatically selected. The STTC with the best performance at the desired prediction type & timespan for the type of data selected by the user is loaded from the Subroutine Repository Database into the Optimizer. The Configured Optimizer is initialized for processing of new input data” step. The process proceeds from this step to step 2548 via link 2561.

Step 2564 is the “Filters and Windows currently or previously under development process the input data in order to generate input for the optimizer” step. The process proceeds from this step to step 2568 via link 2565.

Step 2568 is the “The current statistic is set to the first statistic being input into the optimizer” step. The process proceeds from this step to step 2572 via link 2569.

Step 2572 is the “STTC performs an iteration over the current statistic in order to determine the level of signal present in the statistic useful for performing the desired predictions on the trend data” step. The process proceeds from this step to step 2576 via “Statistic is found to not have sufficient signal” link 2575, or to step 2580 the “Statistic is found to have sufficient signal” link 2574, or to itself (step 2572) via the “Further iterations are needed to determine if the statistic has sufficient prediction signal” link 2573.

Step 2576 is the “The current statistic pointer is then set to the next statistic being received as input to the optimizer” step. The process proceeds from this step to step 2572 via the “More statistics are to be processed” link 2577, or to step 2588 via the “All input statistics have been processed” link 2578.

Step 2580 is the “The current statistic is appended to the list of statistics from which prediction will be made, in the Estimated Statistics-to-Trend Relationship Strength unit. The current statistic pointer is then set to the next statistic being received as input to the optimizer” step. The process proceeds from this step to step 2588 if “All input statistics have been processed” via link 2582 or, in the alternative, to step 2584 via link 2581.

Step 2584 is the “The window, filters and filter builder responsible for creating the statistic are notified to create similar filters and windows and to build filters based on the original and new filters/windows in order to generate related statistics that may have more signal” step. This step leads to the creation of windows, filters, and filter builders that are similar to those already found to as “known-useful”. The process proceeds from this step to step 2572 via the “More statistics are to be processed” link 2585.

Step 2588 is the “Statistics with sufficient signal are loaded into the STTC from the Estimated Statistics-to-Trend Unit. Models are then trained on the relevant statistic data and trend data to accomplish the Goal Configuration. The trained models are saved in the Configured Optimizer and stored as a New Configured Optimizer in the Subroutine Repository Database so that they can be loaded in order to make the desired predictions.” step. The process proceeds from this step to the “End” step (2592) via link 2589, which concludes the process depicted in FIG. 25. In one preferred embodiment the process depicted in FIG. 25 is one iteration in an outer loop that performs multiple iterations of the process depicted in FIG. 25, in which case the “End” step (2592) denotes the end of one iteration.

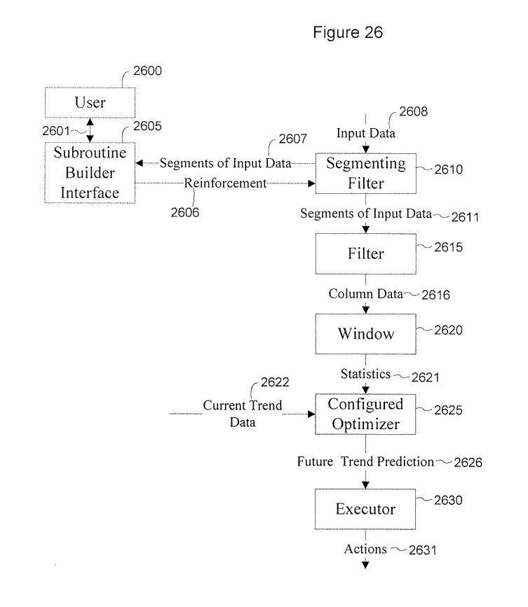

FIG. 26 depicts an information processing and data flow diagram that starts with the User (2600) interacting with the system. The information processing system depicted in FIG. 26 receives input from the Current Trend Data input (2622) and Input Data input (2608). It furthermore outputs Actions (2631) from the Executor (2630) as a result of Future Trend Predictions (2626). In the preferred embodiment depicted in FIG. 26 the system integrates a Segmenting Filter 2610.

The User (2600) interacts with the Subroutine Builder Interface (2605) via link 2601. The Subroutine Builder Interface (2605) is analogous to that (2020) depicted in FIGS. 20 and 24. The Subroutine Builder Interface (2605) interacts with the Segmenting Filter (2606) by receiving Segments of Input Data (2607), which may be presented to the User (2600) via link 2601, and sending it back Reinforcement data (2606) based on the user interaction or some other automated means of reinforcement signal generation. The Input Data (2608) benefits from the Segmenting Filter (2610) in the case that small pieces of the Input Data (2608) contain much more signal for the desired goals of the User (2600) than the rest of the Input Data 2608. In one preferred embodiment, the Input Data (2608) is video data and the Segmenting Filter (2610) has the goal of finding vehicles in the video data. The hypothesized segments (2607) created by the Segmenting Filter (2610) are then sent to the Subroutine Builder Interface (2605), where they may be judged by the User (2600). Such segments may be presented such that, for example, the segmented piece of video is shown with a black background, or with the normal video background but with a red line surrounding the segment. The user can then judge the visualization of the segment, thereby creating a Reinforcement signal (2606) which encourages or discourages the Segmenting Filter (2610) in the creation of more segments like the previously tested segment (2610). In another preferred embodiment, the Segmenting Filter (2610) receives positive reinforcement when downstream AI systems detect that the Segmenting Filter (2610) is performing successfully. For example, when the Future Trend Prediction is accurate relative to the future trend's behavior, then the Segmenting Filter (2610) may be sent positive reinforcement. In this way the segmenting does not have to be perfect to begin with but can improve over time.

The Segments of Input Data (2611) are also sent to the Filter 2615 units, which produce Column Data (2616) that is sent to the Window (2620) units. In another preferred embodiment the Window systems may themselves send their statistics as segments of input data to downstream Filters (2615), which themselves feed into additional downstream window units (2620). Statistics (2621) are sent by window units (2620) to the Configured Optimizer Unit(s) (2625). The Configured Optimizer unit(s) (2625) also receive Current Trend Data (2622) and create predictions on that trend data which is sent as Future Trend Predictions (2626) to the Executor unit(s) (2630). The Executor unit(s) (2630) then perform Actions (2631) that respond to the predicted future of the Trend Data (2626).

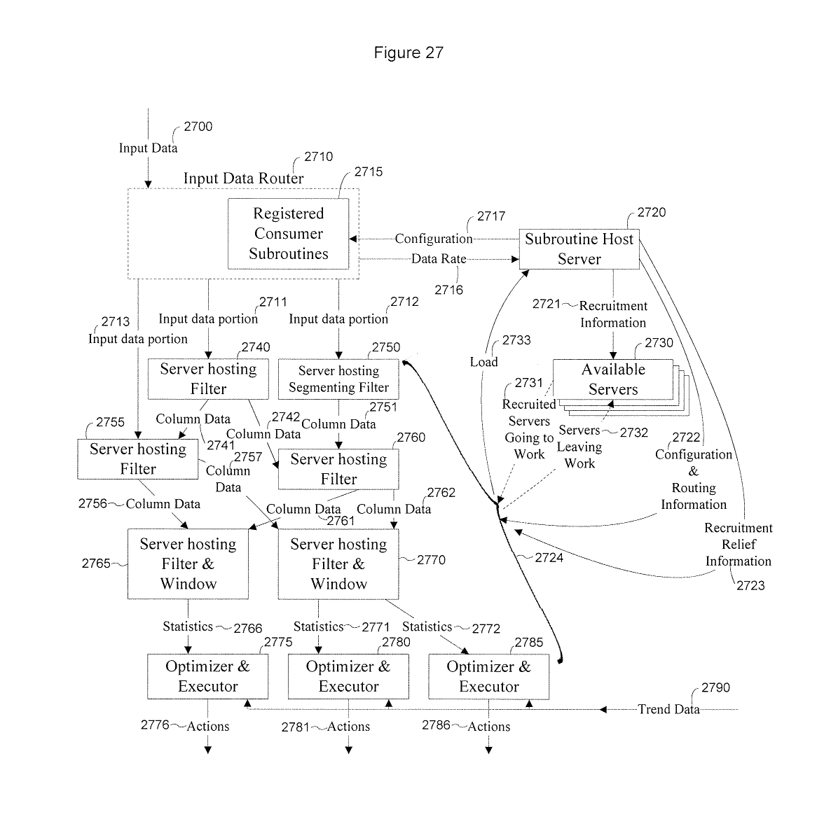

FIG. 27 depicts how the novel system may scale according to changes in the amount of Input Data (2700) that is streamed. This enables the system to use more servers and processing power when more Input Data (2700) requires more work to be completed to keep up with the data in real time.

The Input Data (2700) is input into the Input Data Router (2710). The Input Data Router contains the Registered Consumer Subroutines (2715), which inform the Input Data Router (2710) as to which Server hosting Filters (2740, 2755), and Server hosting Segmenting Filter (2750) should receive a portion of Input data (2711, 2713, 2712). The Registered Consumer Subroutines (2715) are updated via the Configuration data (2717) sent from the Subroutine Host Server (2720). The Input Data Router (2710) in turn sends Data Rate information (2716), which informs the Subroutine Host Server (2720) on how much Input Data (2700) is arriving in real time. This allows the Subroutine Host Server (2720) to respond to the heavier workload that increased Input Data (2700) places on the system. The servers (2740, 2750, 2755, 2760, 2675, 2770, 2775, 2780, 2785), which are described by the bracket as server group 2724, in turn send Load information (2733) to the Subroutine Host Server (2720) which enables the Subroutine Host Server (2720) to correlate the Data Rate (2700) with the required server resources such that a sufficient number can be recruited to handle to current rate of the Input Data (2700).

When the Subroutine Host Server (2720) observes an increase the Data Rate (2716) and anticipates that this will place a load on the currently recruited servers (2724) such that they may lose their real-time response rate, then the Subroutine Host Server (2720) sends Recruitment Information (2721) to one or more Available Servers (2730). The set of Available Servers (2730) that are newly recruited to support the increased workload transition via the “Recruited Servers Going to Work” link 2731. The Subroutine Host Server (2720) then sends Configuration and Routing Information (2722) to the recruited servers (2724) such that the newly recruited servers receive a portion of data for processing. Thus, the newly recruited servers take over a portion of the work and relieve the previously recruited set of servers from having to handle the entire increased load of Input Data (2700).

Conversely, when the Subroutine Host Server (2720) detects from Load information (2733) or Data Rate information (2716) that the set of currently recruited servers (2724) is over provisioned for the current workload, then Recruitment Relief Information (2723) is sent to the relevant servers that are being relieved. This causes the relieved servers to transition from the set of currently recruited servers (2724) back to the set of Available Servers (2730) via the “Servers leaving work” link (2732). The Subroutine Host Server (2720) must also send Configuration and Routing Information (2722) so that the relieved servers do not have any data processing workload routed to them. The Subroutine Host Server (2720) also notifies the Registered Consumer Subroutines (2715) via the Configuration link (2717) that Input Data (2711, 2712, 2713) should not be routed to the relieved servers.

For completeness, as previously described, the Server hosting Filters (2740), may send Column Data (2741, 2742) to other Server hosting Filters (2755, 2760). The Server hosting Filter (2755) also receives its Input data portion from the Input Data Router (2710) and produces Column Data output (2756), which is sent to the Server hosting Filter and Window (2765). The Server hosting Filter (2760) receives Column Data (2742, 2757) from the Server hosting Filter and Server hosting Segmenting Filter (2740, 2750), and may send Column Data output (2761, 2762) to Servers hosting Filter and Window (2765, 2770).

The Servers hosting Filters and Windows (2765, 2770) send Statistics (2761, 2771, 2772) to Optimizer and Executors (2775, 2780, 2785) depending on which Statistics are required by the particular Optimizer and Executor (2775, 2780, 2785). The Optimizer and Executor (2775, 2780, 2785) receive Trend Data input (2790) and, based on the predictions they produce, enact Actions (2776, 2780, 2786).

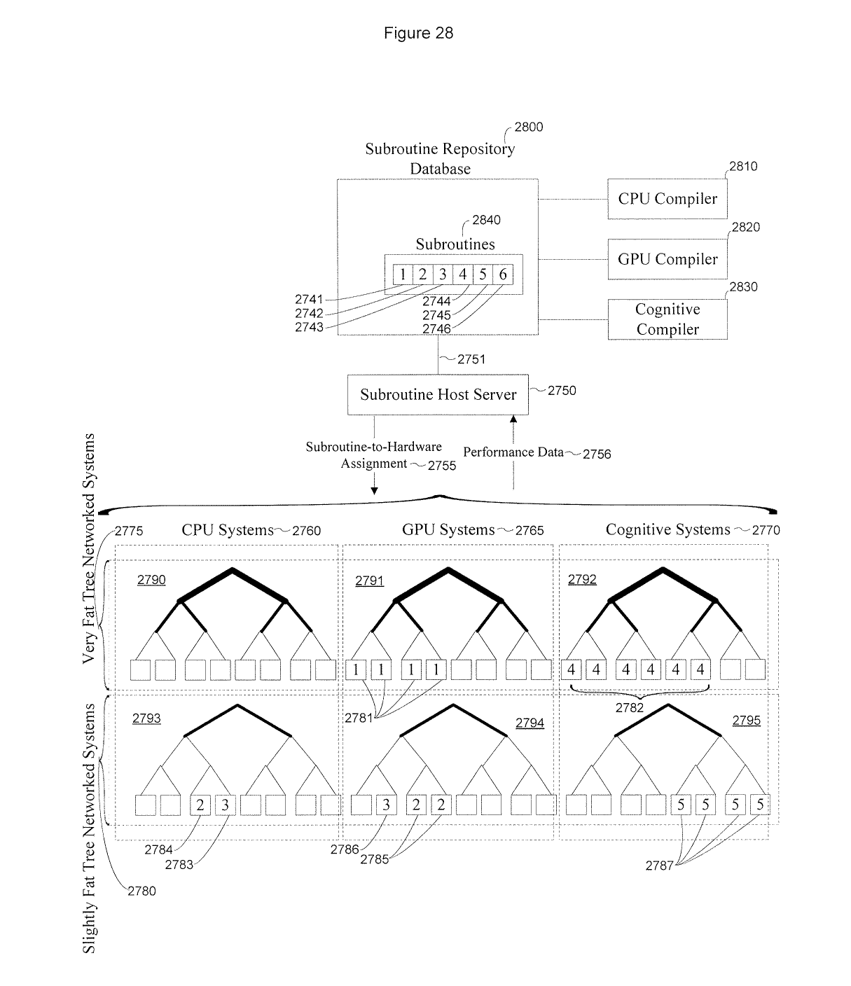

FIG. 28 depicts how the novel system may run Subroutines (2740) on particular systems (2790-2795) and subnetworks within those systems (2781-2787) such that the Subroutines that run best on a certain system and network configuration are assigned to those systems and their subnetwork is assigned such that the bandwidth requirements of those subroutines are met. This allows the system to perform the subroutines (2840) in real time at the lowest cost possible since the fewest systems of the optimal type will be required for a given subroutine to achieve real time. In contrast, assignment of subroutines to execute on non-optimal computer systems results in the recruitment of a more costly contingent of computing resources in order to deliver the execution of the subroutines in real time. The Subroutine Repository Database (2800, analogous to 2010) stores performance information for each of the subroutines (2741-2746). This information is collected by compiling each of the subroutines using a CPU Compiler, GPU Compiler, and Cognitive Compiler (2810, 2820, 2830). In some preferred embodiments other types of systems may be used such as Tilera many-core architectures [Villalpando, C. Y., Johnson, A. E., Some, R., Oberlin, J., & Goldberg, S. (2010, March). Investigation of the Tilera processor for real time hazard detection and avoidance on the Altair Lunar Lander. In Aerospace Conference, 2010 IEEE (pp. 1-9). IEEE], and their compiler would then be included in the list of compilers alongside the set of compilers included in FIG. 28 (2810, 2820, 2830).

Once a compilation of a subroutine has been made it can be tested in order to determine its performance and performance-per-watt on that system. It can be further tested for its bandwidth requirements. For example different network topologies may be available for the same architecture, one with high bandwidth (2775) and one with less bandwidth between distant nodes (2780). Once the performance of the subroutines has been measured on the various systems (2790-2795) this Performance Data information (2756) is transmitted from these systems (2790-2795) to the Subroutine Host Server (2750, analogous to 2720), which stores aggregated summaries of this data back in the Subroutine Repository Database (2800) via link 2751.

In another preferred embodiment, performance at a subset of the total set of configurations is sufficient to estimate performance on the other systems, and so each subroutine need only be tested on a few, or some non-exhaustive set of systems. For example, poor performance of a subroutine on an AMD-based GPU system may be sufficient to predict poor performance on an Nvidia-based GPU system. In another embodiment poor performance on lower-bandwidth systems (2780) anticipates the possibility of better performance on higher bandwidth systems (2775) which, with additional evidence, may support testing of additional systems only in the very fat tree networked systems. The bandwidth-to-work completed correlation may be calculated by the Subroutine Host Server (2750) from the Performance Data (2756). In this way the required network (2775, 2780) can be predicted from the workload completion rate when the subroutine is run on different systems (2760, 2765, 2770).

The novel system uses the summarized performance data stored in the Subroutine Repository Database (2800) to assign subroutines (2741-2746) to the hardware on which it performs best. Subroutines that communicate with each other are assigned to be in the same subnetwork. For example, in system 2793, subroutines #2 and #3 (2742, 2743) are executed on the same subnetwork comprising nodes 2783 and 2784. In other cases they may not need to run in the same subnetwork. This is the case with Subroutine 5 (2745) and Subroutine 4 (2744), which are run on separate networks (2792, 2795) and thus may not have high bandwidth communication with each other. The subroutines would be allocated to hardware resources in this manner if it is anticipated that subnetwork separation will not decrease performance, which would be the case if these subroutines subroutines do not communicate with each other. In another preferred embodiment, a subroutine may be migrated from a lower performing computer hardware, such as a 2 Ghz Celeron Intel Processor, to a higher performing version within the same architecture, such as a 3 Ghz Celeron Intel Processor. In this case additional hardware is not recruited, but rather higher performing hardware is only used when it is needed, and in this case it may simply be migrated from lower performing hardware. Such migration would be controlled by the demand placed on the system by the incoming data (2700).

Another aspect of the novel system is that the interactive CQL query builder process of FIG. 11 may be performed by staff dedicated to operating the interactive CQL query builder. It would be then be possible for users to specify to a staff member what the CQL query should do, and to do this specification in more colloquial terms than what a computer would automatically understand. In another preferred embodiment, the Segments of Input Data (2607) and Reinforcement (2606) interaction with the Subroutine Builder Interface (2605) may be operated by a staff member in order to improve the segmenting operation without requiring the User's (2600) time. This may work well for visual datasets, for example, since computers generally start out poor at segmenting images and videos, but humans find this task trivial. In this way the User (2600) may operate nearly all of the Subroutine Builder Interface (2605), performing all interactions except those that can be performed by a staff member and do not need the User (2600). In this way not only is the User's (2600) time optimized by having the computer guide the User (2600) as efficiently as possible, but the User (2600) is enabled to trade money for time in certain circumstances, where additional human training of the computer system is beneficial but does not require the User's (2600) expertise.

It is also noteworthy that the Optimizer (2400) may continue to optimize the Configured Optimizer (2460) based on reports on real-time data from the STTC (2430). In this way the system continuously improve and also adjust to changes in the input data stream. By using the Input Trend (2420) as supervised data (that we merely try to predict in advance), we can adjust to changes in performance since the supervised data allows us to constantly monitor performance.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A method for interactive construction of data queries comprising:
generating a query based upon a plurality of user-identified data items wherein the user-identified data items are data items representing desired results from a query, and wherein information related to the user-identified data items is included in a “given” clause of the query;
assigning received input data to a hierarchical set of categories;
presenting to a user a plurality of new query results, wherein the plurality of new query results are determined by scanning the received input data to find data elements in the same hierarchical categories as those in the “given” clause of the query and not in the same hierarchical categories as those of an “unlike” clause of the query;
receiving from the user an indication as to whether each query result of the presented plurality of new query results is a desirable query result;
adding query results indicated by the user as desirable to the “given” clause of the query;
adding query results indicated by the user as undesirable to the “unlike” clause of the query;
evaluating a metric indicative of the accuracy of the query;
evaluating a metric indicative of the recall of the query; and
responsive to a determination that the query achieves a predetermined threshold level of accuracy and recall, storing the query.

2. The method of claim 1 wherein the received input data comprises a set of audio music files.

3. The method of claim 2 wherein hierarchical sets of categories correspond to the genre of the music contained in an audio music file.

4. The method of claim 1 wherein the received input data comprises a set of images.

5. The method of claim 1 wherein the received input data comprises a set of videos.

6. The method of claim 5 further comprising:
presenting videos to a user; and
receiving from the user a positive or negative response corresponding to whether the videos being presented to the user should be added to the “given” clause or the “unlike” clause respectively.

7. The method of claim 6 further wherein hierarchical sets of categories correspond to the genre of the video, including a category for video sequences containing moving animals such as common pets.

8. A real-time data predictor generating computing system comprising:
(a) a plurality of filter host computer servers configured to execute filter operations assigning a hierarchical set of categories to a received input;
(b) a plurality of statistic window host computer servers configured to execute statistic window operations assigning statistics collected over time to a set of categories and trend target data received as input;
(c) a statistics-to-trend target comparator host computer server receiving trend target data as input and configured to execute comparator operations assigning relationship strength to statistics collected over time and received as input;
(d) a memory for storing host computer server configurations and loading host computer server configurations into host computer servers; and
(e) an optimizer that selects filter configurations, statistic window configurations, and statistics-to-trend target comparator configurations;
wherein the optimizer receives a user-provided goal configuration explaining the desired relationship between the trend data elements and output statistics,
wherein the goal configuration defines length of time in the future that the output statistics are to be used to predict the trend data,
wherein the goal configuration defines the desired relationship strength,
wherein the goal configuration describes the type of data found in the input data stream and the type of data in the trend data stream,
wherein the optimizer selects the configurations that will be used next to configure the filters, statistic windows, and statistics-to-trend target comparators to find a set of configurations that, when used together, result in a sufficiently high relationship strength,
wherein the configurations that are selected by the optimizer first are matched according to prior success when processing input data similar to the goal configuration input data stream type, and when processing trend data similar to the goal configuration trend data type,
wherein if the configurations that are selected by the optimizer result in a relationship strength that is not sufficient according to the goal configuration then a different set of configurations is selected by the optimizer from the memory storing host computer server configurations, and
wherein if the configurations that are selected by the optimizer result in a relationship strength that is sufficient according to the goal configuration then the selected combination of configurations is added to the memory storing host computer server configurations as a new configuration entry marked to note that the added configuration has been previously successful in the case of the current goal configuration.

9. The computing system of claim 8 further comprising: (f) a statistics-to-trend target comparator host computer server configured with a statistics-to-trend target comparator configuration adapted for receiving a trend target data stream comprising a stock ticker data stream.

10. The computing system of claim 8 further comprising: (f) a filter host computer server configured with a filter configuration adapted for receiving an input data stream of short text messages such as a Twitter feed.

11. The computing system of claim 10 wherein the data stream of short text messages comprises a random subsample of a much larger stream that may be unavailable in its entirety.

12. The computing system of claim 8 further comprising: (f) a filter host computer server configured with a filter configuration adapted for assigning a category representing an estimated mood or sentiment of the input data element being categorized according to whether the input data element contains certain keywords.

13. The computing system of claim 8 further comprising: (f) a filter host computer server configured with a filter configuration adapted for receiving an input data stream of audio data.

14. The computing system of claim 13 further comprising: (g) a statistics-to-trend target comparator host computer server configured with a statistics-to-trend target comparator configuration adapted for receiving a trend target data stream comprising the text of words spoken in the audio stream.

15. A method of constructing a real time data processing application comprising:
presenting to a user a plurality of configurations that may be used to configure host computer servers;
receiving from the user an indication of which configurations are to be used to make a new configuration;
presenting to a user the input and output connections of the selected configurations;
receiving from the user a plurality of assignments of the configuration outputs to configuration inputs;
presenting to a user a plurality of available input data streams;
receiving from the user an indication of the plurality of input data streams that are appropriate for the new application;
presenting to a user a plurality of available trend target data streams;
receiving from the user an indication as to which trend target data stream is appropriate for the new application;
compiling the new application for different host computing server architectures;
configuring a plurality of host computer servers with heterogeneous architectures and networks with the newly constructed application;
providing the newly configured host computer servers with data from the input data stream selected by the user;
measuring the performance and efficiency of each host computer server architecture and network in order to determine which architecture is most efficient at performing each component configuration of the new application;
adding to a memory storing a plurality of host computer server configurations the new application marked with the user selections and measured performance and efficiency; and
loading of the new application from the memory storing a plurality of host computer server configurations such that host computer servers that are configured with the new application are those that the new application has been marked to run most efficiently on.

16. The method of claim 15 wherein the heterogeneous set of host computing server architectures and networks comprises a collection of Graphics Processing Units connected via high speed fat-tree network.

17. The method of claim 16 wherein the fat-tree network supports communication between any two Graphics Processing Units at the maximum speed at which the Graphics Processing Units can input and output data onto the bus to which they are connected.

18. The method of claim 15 wherein the computer architectures are optimized for execution of standard parallel software that has not been optimized for hardware acceleration beyond the declaration of many threads and/or processes.

19. The method of claim 1 wherein the configurations comprise filter configurations adapted for assigning output categories that are accessible to computer systems traditionally adapted for only connecting to standard databases using standard queries.

20. The method of claim 19 wherein each of the filter configurations whose assigned category outputs are exposed to traditional standard-database-connecting systems assign a database column to each level in the hierarchy from the filter assigned categories, wherein the value assigned by such a filter for a given input data element for a given column is the name of the category that is assigned by that filter at the corresponding hierarchy level, wherein the traditional system is able to retrieve a subset of data that has been hierarchically categorized in a certain set of categories by a certain filter configuration by specifying in a query which categories are desired in which hierarchy levels assigned by which filter configuration, and wherein other columns not specified in the query do not affect the query result.
